(19) United States
(12) Patent Application Publication
(10) Pub. No.: US 2026/0021957 A1
(43) Pub. Date: Jan. 22, 2026

(54) SELECTIVELY REMOVABLE RECEPTACLE WITH SECURING ELEMENTS

(71) Applicant: KRISTINA CASEL, SHERMAN, TX (US)

(72) Inventor: KRISTINA CASEL, SHERMAN, TX (US)

(21) Appl. No.: 19/268,065

(22) Filed: Jul. 14, 2025

Related U.S. Application Data
(60) Provisional application No. 63/671,993, filed on Jul. 16, 2024.

(51) Int. Cl. B65F 1/00; B65F 1/06

(52) U.S. Cl. CPC B65F 1/0006; B65F 1/06; B65F 2210/1125; B65F 2210/18; B65F 2250/105

(57) ABSTRACT

A selectively removable receptacle with securing elements for engaging a container is provided. The selectively removable receptacle may be configured as a bag for use in various containers, such as, but not limited to, trash and/or recycling containers. The receptacle or bag may include one or more securing elements, such as adhesives, that secure the bag to the inside of the container while concealing the presence of the bag when viewing the container from the outside. The adhesive elements prevent the bag from falling or sliding down into the container either by gravity or when items are placed inside the bag that is positioned inside the container.

### CROSS REFERENCE TO RELATED APPLICATIONS

Pursuant to 35 U.S.C. § 119 (e), this non-provisional patent application claims the benefit of, and priority to, U.S. Provisional Patent Application No. 63/671,993 titled “Selectively Removable Receptacle with Securing Elements,” filed Jul. 16, 2024, the disclosure of which is incorporated herein in its entirety by reference

### FIELD OF THE INVENTION

The present invention relates generally to receptacle liners or bags, and more specifically to receptacles with integrated securing elements that allow for concealed and stable positioning within a container, such as a waste bin or recycling receptacle.

### BACKGROUND OF THE DISCLOSURE

Garbage receptacles or containers are often used together with liners. These liners are often replaceable plastic bags or bags made of other suitable material, such as recyclable materials. Often these liners or garbage bags are secured to garbage receptacles in a number of ways.

In some situations, the containers include a lid which captures a portion of the garbage bag containing the opening. By clamping or frictional means, the garbage bag is held in place to be fully extended or opened within the receptacle, to receive trash, recyclables, or other items to be disposed within.

In other situations, the containers are larger or roughly the same size as the garbage bags placed within. For cases where the bags are larger, a user may extend the bag over the exterior of the container, causing the bag to be visible and may be unsightly or unappealing. Additionally, items placed within the bag when placed in the container may cause the bag to pull inside the container. This may further result in the contents of the bag at least partially emptying into the container, another undesirable situation.

In yet other situations, garbage bags may be tied around the perimeter of the container, or secured to features included on the container, such as hooks, handles, levers, or other devices that are meant to perform that function or other functions of the container, such as to engage a lid that secures the container opening.

All of these situations or configurations include various drawbacks and other undesirable features and/or results. What is needed then is a garbage bag with an integrated adhesive that secures the bag to the interior of the container, hiding the bag from view and also preventing the bag from sliding down within the container as it fills with discarded items, but also allows a user to remove the bag when desired.

### SUMMARY OF THE INVENTION

In accordance with various aspects of the present invention, a receptacle system is disclosed for improved retention and concealment within a container. The system includes a bag with one or more integrated securing elements configured to adhere or fasten to interior surfaces of a container.

In one embodiment, the invention provides a receptacle including a bag having a front panel, a back panel, opposing side edges, a defined opening, and a closed bottom. At least one securing element is affixed to the exterior surface of the bag. The securing element includes an adhesive material that selectively adheres to an interior wall of a container, thereby retaining the bag in place and concealing it from exterior view during use.

Further refinements of this embodiment may include:
Positioning the adhesive material near the bag's opening.
Covering the adhesive material with a removable protective film.
Using pressure-sensitive adhesive strips that extend across at least 50% of the bag's width.
Providing opposing adhesive elements on the lateral sides of the bag.
Including color-coded adhesive zones to indicate location or strength.
Using repositionable adhesives for multiple uses.
Constructing the bag from biodegradable material with compostable adhesive.

In another embodiment, a receptacle is provided with a plurality of securing elements placed at different vertical positions on the bag's exterior. These securing elements—made of adhesive, magnetic, or mechanical fasteners—anchor the bag at multiple points to the container's interior to prevent slippage.

Additional features may include:
Placement of adhesive strips near both the bag opening and a midpoint along its height.
Configuration of the securing elements as horizontal bands extending partially around the bag.
Use of magnetic pads enclosed in protective sleeves.
Location of securing elements on side gussets of the bag.
Use of visual markings to guide user placement.

In yet another embodiment, a complete receptacle system is disclosed, including:
A disposable bag with a top opening, a bottom, and at least one handle.
One or more securing elements selected from hook-and-loop fasteners, magnetic fasteners, or reusable adhesive pads.
A kit that includes matching fastener surfaces, such as adhesive-backed hook strips, for placement inside a container to engage with the bag's securing elements and maintain its position.

Additional refinements of this system may include:
Mounting the securing element on an outwardly extending tab from the bag.
Inclusion of an installation guide and applicator for affixing the fastener interface to the container.
Biodegradable or compostable construction of the bag.
Configuring the securing element to be removably attached via a slot or channel in the bag body.

The present invention provides several advantages, including: concealed appearance of waste bags within containers; prevention of bag slippage due to adhesive or fastening retention; compatibility with various container shapes and sizes; environmentally-friendly embodiments using biodegradable materials, and enhanced user convenience through integrated or detachable fasteners.

These and other features of the invention will be more readily understood from the following detailed description and accompanying drawings.

### BRIEF DESCRIPTION OF DRAWINGS

The figures disclosed herein illustrate a variety of non-limiting embodiments of the receptacle, particularly variations in the number, shape, placement, and orientation of securing elements. These illustrations are intended to show the breadth of possible configurations rather than prescribe exact dimensions or locations. For example, the securing elements may appear as rectangles, squares, circles, triangles, bands, or custom shapes, and may be positioned near the bag opening, midsection, sides, or bottom. The choice and arrangement of these securing elements may depend on the container type, bag material, intended use, or desired concealment. It should be understood that equivalent securing element placements and shapes not expressly shown in the figures are also contemplated and within the scope of the present invention.

The disclosure is described in greater detail by way of example only and with reference to the attached drawings, in which:

FIG. 1A is a front view of an embodiment of the present disclosure showing a selectively removable receptacle with a securing element covered with a protective film;

FIG. 1B is a front view of an embodiment of the present disclosure showing a selectively removable receptacle with a securing element partially covered with a protective film;

FIG. 1C is a front view of an embodiment of the present disclosure showing a selectively removable receptacle with a securing element with the protective film removed;

FIG. 2A is a front view of an embodiment of the present disclosure showing a selectively removable receptacle with a securing element covered with a protective film;

FIG. 2B is a front view of an embodiment of the present disclosure showing a selectively removable receptacle with a securing element partially covered with a protective film;

FIG. 2C is a front view of an embodiment of the present disclosure showing a selectively removable receptacle with a securing element with the protective film removed;

FIG. 3A is a front view of an embodiment of the present disclosure showing a selectively removable receptacle with securing elements with the protective film removed;

FIG. 3B is a back view of an embodiment of the present disclosure showing a selectively removable receptacle with securing elements with the protective film removed;

FIG. 3C is a right-side view of an embodiment of the present disclosure showing a selectively removable receptacle with a securing element with the protective film removed;

FIG. 3D is a left-side view of an embodiment of the present disclosure showing a selectively removable receptacle with a securing element with the protective film removed;

FIG. 4A is a front view of an embodiment of the present disclosure showing a selectively removable receptacle with a securing element with the protective film removed;

FIG. 4B is a back view of an embodiment of the present disclosure showing a selectively removable receptacle with a securing element with the protective film removed;

FIG. 4C is a right-side view of an embodiment of the present disclosure showing a selectively removable receptacle with a securing element with the protective film removed;

FIG. 4D is a left-side view of an embodiment of the present disclosure showing a selectively removable receptacle;

FIG. 5A is a front view of an embodiment of the present disclosure showing a selectively removable receptacle with a securing element with the protective film removed;

FIG. 5B is a back view of an embodiment of the present disclosure showing a selectively removable receptacle with a securing element with the protective film removed;

FIG. 5C is a right-side view of an embodiment of the present disclosure showing a selectively removable receptacle with securing elements with the protective film removed;

FIG. 5D is a left-side view of an embodiment of the present disclosure showing a selectively removable receptacle with securing elements with the protective film removed;

FIG. 6A is a front view of an embodiment of the present disclosure showing a selectively removable receptacle with a securing element with the protective film removed;

FIG. 6B is a back view of an embodiment of the present disclosure showing a selectively removable receptacle;

FIG. 6C is a right-side view of an embodiment of the present disclosure showing a selectively removable receptacle with a securing element with the protective film removed;

FIG. 6D is a left-side view of an embodiment of the present disclosure showing a selectively removable receptacle with a securing element with the protective film removed;

FIG. 7A is a front view of an embodiment of the present disclosure showing a selectively removable receptacle with a securing element with the protective film removed;

FIG. 7B is a back view of an embodiment of the present disclosure showing a selectively removable receptacle with securing elements with the protective film removed;

FIG. 7C is a right-side view of an embodiment of the present disclosure showing a selectively removable receptacle with securing elements with the protective film removed;

FIG. 7D is a left-side view of an embodiment of the present disclosure showing a selectively removable receptacle with securing elements with the protective film removed;

FIG. 8A is a front view of an embodiment of the present disclosure showing a selectively removable receptacle with a securing element with the protective film removed;

FIG. 8B is a back view of an embodiment of the present disclosure showing a selectively removable receptacle with securing elements with the protective film removed;

FIG. 8C is a right-side view of an embodiment of the present disclosure showing a selectively removable receptacle with securing elements with the protective film removed;

FIG. 8D is a left-side view of an embodiment of the present disclosure showing a selectively removable receptacle with securing elements with the protective film removed;

FIG. 9A is a front view of an embodiment of the present disclosure showing a selectively removable receptacle with securing elements with the protective film removed;

FIG. 9B is a back view of an embodiment of the present disclosure showing a selectively removable receptacle with securing elements with the protective film removed;

FIG. 9C is a right-side view of an embodiment of the present disclosure showing a selectively removable receptacle with securing elements with the protective film removed;

FIG. 9D is a left-side view of an embodiment of the present disclosure showing a selectively removable receptacle with securing elements with the protective film removed;

FIG. 10A is a front view of an embodiment of the present disclosure showing a selectively removable receptacle with securing elements with the protective film removed;

FIG. 10B is a back view of an embodiment of the present disclosure showing a selectively removable receptacle with securing elements with the protective film removed;

FIG. 10C is a right-side view of an embodiment of the present disclosure showing a selectively removable receptacle with securing element with the protective film removed;

FIG. 10D is a left-side view of an embodiment of the present disclosure showing a selectively removable receptacle with a securing element with the protective film removed;

FIG. 11A is a front view of an embodiment of the present disclosure showing a selectively removable receptacle with securing elements with the protective film removed;

FIG. 11B is a back view of an embodiment of the present disclosure showing a selectively removable receptacle with securing elements with the protective film removed;

FIG. 11C is a right-side view of an embodiment of the present disclosure showing a selectively removable receptacle with a securing element with the protective film removed;

FIG. 11D is a left-side view of an embodiment of the present disclosure showing a selectively removable receptacle with a securing element with the protective film removed;

FIG. 12A is a front view of an embodiment of the present disclosure showing a selectively removable receptacle with securing elements with the protective film removed;

FIG. 12B is a back view of an embodiment of the present disclosure showing a selectively removable receptacle with securing elements with the protective film removed;

FIG. 12C is a right-side view of an embodiment of the present disclosure showing a selectively removable receptacle with a securing element with the protective film removed;

FIG. 12D is a left-side view of an embodiment of the present disclosure showing a selectively removable receptacle with a securing element with the protective film removed;

FIG. 13 is a front or back view of an embodiment of the present disclosure showing a selectively removable receptacle with a securing element with the protective film removed;

FIG. 14 is a front or back view of an embodiment of the present disclosure showing a selectively removable receptacle with a securing element with the protective film removed;

FIG. 15 is a front or back view of an embodiment of the present disclosure showing a selectively removable receptacle with a securing element with the protective film removed;

FIG. 16 is a front or back view of an embodiment of the present disclosure showing a selectively removable receptacle with a securing element with the protective film removed;

FIG. 17 is a front or back view of an embodiment of the present disclosure showing a selectively removable receptacle with a securing element with the protective film removed;

FIG. 18 is a front or back view of an embodiment of the present disclosure showing a selectively removable receptacle with a securing element with the protective film removed;

FIG. 19 is a front or back view of an embodiment of the present disclosure showing a selectively removable receptacle with a securing element with the protective film removed;

FIG. 20 is a front or back view of an embodiment of the present disclosure showing a selectively removable receptacle with securing elements with the protective film removed;

FIG. 21A is a front view of an embodiment of the present disclosure showing a selectively removable receptacle with a securing element with the protective film removed;

FIG. 21B is a back view of an embodiment of the present disclosure showing a selectively removable receptacle with a securing element with the protective film removed;

FIG. 21C is a right or left side view of an embodiment of the present disclosure showing a selectively removable receptacle with a securing element with the protective film removed;

FIG. 22A is a front view of an embodiment of the present disclosure showing a selectively removable receptacle with securing elements with the protective film removed;

FIG. 22B is a back view of an embodiment of the present disclosure showing a selectively removable receptacle with securing elements with the protective film removed;

FIG. 22C is a right or left side view of an embodiment of the present disclosure showing a selectively removable receptacle with securing elements with the protective film removed;

FIG. 23A is a front view of an embodiment of the present disclosure showing a selectively removable receptacle with securing elements with the protective film removed;

FIG. 23B is a back view of an embodiment of the present disclosure showing the selectively removable receptacle of FIG. 23A;

FIG. 23C is a right or left side view of an embodiment of the present disclosure showing the selectively removable receptacle of FIG. 23A with securing elements with the protective film removed;

FIG. 24A is a front view of an embodiment of the present disclosure showing a selectively removable receptacle with securing elements with the protective film removed;

FIG. 24B is a back view of an embodiment of the present disclosure showing the selectively removable receptacle of FIG. 24A with securing elements with the protective film removed;

FIG. 24C is a right or left side view of an embodiment of the present disclosure showing the selectively removable receptacle of FIG. 24A with securing elements with the protective film removed;

FIG. 25A is a front view of an embodiment of the present disclosure showing a selectively removable receptacle with securing elements with the protective film removed;

FIG. 25B is a back view of an embodiment of the present disclosure showing the selectively removable receptacle of FIG. 25A;

FIG. 25C is a right or left side view of an embodiment of the present disclosure showing the selectively removable receptacle of FIG. 25A with a securing element with the protective film removed;

FIG. 26A is a front view of an embodiment of the present disclosure showing a selectively removable receptacle with a securing element with the protective film removed;

FIG. 26B is a back view of an embodiment of the present disclosure showing the selectively removable receptacle of FIG. 26A with a securing element with the protective film removed;

FIG. 26C is a right or left side view of an embodiment of the present disclosure showing the selectively removable receptacle of FIG. 26A with a securing element with the protective film removed;

FIG. 27A is a front view of an embodiment of the present disclosure showing a selectively removable receptacle with a securing element with the protective film removed;

FIG. 27B is a back view of an embodiment of the present disclosure showing the selectively removable receptacle of FIG. 27A;

FIG. 27C is a right or left side view of an embodiment of the present disclosure showing the selectively removable receptacle of FIG. 27A with a securing element with the protective film removed;

FIG. 28A is a front view of an embodiment of the present disclosure showing a selectively removable receptacle with a securing element with the protective film removed;

FIG. 28B is a back view of an embodiment of the present disclosure showing the selectively removable receptacle of FIG. 28A with a securing element with the protective film removed;

FIG. 28C is a right or left side view of an embodiment of the present disclosure showing the selectively removable receptacle of FIG. 28A with a securing element with the protective film removed;

FIG. 29A is a front view of an embodiment of the present disclosure showing a selectively removable receptacle with a securing element with the protective film removed;

FIG. 29B is a back view of an embodiment of the present disclosure showing the selectively removable receptacle of FIG. 29A;

FIG. 29C is a right or left side view of an embodiment of the present disclosure showing the selectively removable receptacle of FIG. 29A with a securing element with the protective film removed;

FIG. 30A is a front view of an embodiment of the present disclosure showing a selectively removable receptacle with a securing element with the protective film removed;

FIG. 30B is a back view of an embodiment of the present disclosure showing the selectively removable receptacle of FIG. 30A with a securing element with the protective film removed;

FIG. 30C is a right or left side view of an embodiment of the present disclosure showing the selectively removable receptacle of FIG. 30A with a securing element with the protective film removed;

FIG. 31A is a front view of an embodiment of the present disclosure showing a selectively removable receptacle with a securing element with the protective film removed;

FIG. 31B is a back view of an embodiment of the present disclosure showing the selectively removable receptacle of FIG. 31A;

FIG. 31C is a right or left side view of an embodiment of the present disclosure showing the selectively removable receptacle of FIG. 31A with a securing element with the protective film removed;

FIG. 32A is a front view of an embodiment of the present disclosure showing a selectively removable receptacle with a securing element with the protective film removed;

FIG. 32B is a back view of an embodiment of the present disclosure showing the selectively removable receptacle of FIG. 32A with a securing element with the protective film removed;

FIG. 32C is a right or left side view of an embodiment of the present disclosure showing the selectively removable receptacle of FIG. 32A with a securing element with the protective film removed;

FIG. 33 is a front or back view of an embodiment of the present disclosure showing a selectively removable receptacle with a securing element with the protective film removed;

FIG. 34 is a front or back view of an embodiment of the present disclosure showing the selectively removable receptacle with securing elements with the protective film removed;

FIG. 35 is a right or left side view of an embodiment of the present disclosure showing the selectively removable receptacle of FIG. 33 or 34 with a securing element(s) with the protective film removed;

FIG. 36 is a front or back view of an embodiment of the present disclosure showing a selectively removable receptacle with securing elements with the protective film removed;

FIG. 37 is a front or back view of an embodiment of the present disclosure showing the selectively removable receptacle with a securing element with the protective film removed;

FIG. 38 is a right or left side view of an embodiment of the present disclosure showing the selectively removable receptacle of FIG. 36 or 37 with a securing element(s) with the protective film removed;

FIG. 39A is a front view of an embodiment of the present disclosure showing a selectively removable receptacle with securing elements with the protective film removed;

FIG. 39B is a back view of an embodiment of the present disclosure showing the selectively removable receptacle of FIG. 39A with securing elements with the protective film removed;

FIG. 39C is a right or left side view of an embodiment of the present disclosure showing the selectively removable receptacle of FIG. 39A with a securing element with the protective film removed;

FIG. 40A is a front view of an embodiment of the present disclosure showing a selectively removable receptacle with securing elements with the protective film removed;

FIG. 40B is a back view of an embodiment of the present disclosure showing the selectively removable receptacle of FIG. 40A;

FIG. 40C is a right or left side view of an embodiment of the present disclosure showing the selectively removable receptacle of FIG. 40A with securing elements with the protective film removed;

FIG. 41A is a front view of an embodiment of the present disclosure showing a selectively removable receptacle with securing elements with the protective film removed;

FIG. 41B is a back view of an embodiment of the present disclosure showing the selectively removable receptacle of FIG. 41A with securing elements with the protective film removed;

FIG. 41C is a right or left side view of an embodiment of the present disclosure showing the selectively removable receptacle of FIG. 41A with a securing element with the protective film removed;

FIG. 42A is a front view of an embodiment of the present disclosure showing a selectively removable receptacle with securing elements with the protective film removed;

FIG. 42B is a back view of an embodiment of the present disclosure showing the selectively removable receptacle of FIG. 42A with securing elements with the protective film removed;

FIG. 42C is a right or left side view of an embodiment of the present disclosure showing the selectively removable receptacle of FIG. 42A with a securing element with the protective film removed;

FIG. 43A is a front view of an embodiment of the present disclosure showing a selectively removable receptacle with securing elements with the protective film removed;

FIG. 43B is a back view of an embodiment of the present disclosure showing the selectively removable receptacle of FIG. 43A with securing elements with the protective film removed;

FIG. 43C is a right or left side view of an embodiment of the present disclosure showing the selectively removable receptacle of FIG. 43A with a securing element with the protective film removed;

FIG. 44A is a front view of an embodiment of the present disclosure showing a selectively removable receptacle with securing elements with the protective film removed;

FIG. 44B is a back view of an embodiment of the present disclosure showing the selectively removable receptacle of FIG. 44A with securing elements with the protective film removed;

FIG. 44C is a right or left side view of an embodiment of the present disclosure showing the selectively removable receptacle of FIG. 44A with a securing element with the protective film removed;

FIG. 45A is a front view of an embodiment of the present disclosure showing a selectively removable receptacle with securing elements with the protective film removed;

FIG. 45B is a back view of an embodiment of the present disclosure showing the selectively removable receptacle of FIG. 45A with securing elements with the protective film removed;

FIG. 45C is a right or left side view of an embodiment of the present disclosure showing the selectively removable receptacle of FIG. 45A with a securing element with the protective film removed;

FIG. 46A is a front view of an embodiment of the present disclosure showing a selectively removable receptacle with securing elements with the protective film removed;

FIG. 46B is a back view of an embodiment of the present disclosure showing the selectively removable receptacle of FIG. 46A with securing elements with the protective film removed;

FIG. 46C is a right or left side view of an embodiment of the present disclosure showing the selectively removable receptacle of FIG. 46A with a securing element with the protective film removed;

FIG. 47A is a front view of an embodiment of the present disclosure showing a selectively removable receptacle with a securing element with the protective film removed;

FIG. 47B is a back view of an embodiment of the present disclosure showing the selectively removable receptacle of FIG. 47A;

FIG. 47C is a right or left side view of an embodiment of the present disclosure showing the selectively removable receptacle of FIG. 47A with a securing element with the protective film removed;

FIG. 48A is a front view of an embodiment of the present disclosure showing a selectively removable receptacle with a securing element with the protective film removed;

FIG. 48B is a back view of an embodiment of the present disclosure showing the selectively removable receptacle of FIG. 48A;

FIG. 48C is a right or left side view of an embodiment of the present disclosure showing the selectively removable receptacle of FIG. 48A with a securing element with the protective film removed;

FIG. 49A is a front view of an embodiment of the present disclosure showing a selectively removable receptacle with securing elements with the protective film removed;

FIG. 49B is a back view of an embodiment of the present disclosure showing the selectively removable receptacle of FIG. 49A;

FIG. 49C is a right or left side view of an embodiment of the present disclosure showing the selectively removable receptacle of FIG. 49A with securing elements with the protective film removed;

FIG. 50A is a front view of an embodiment of the present disclosure showing a selectively removable receptacle with securing elements with the protective film removed;

FIG. 50B is a back view of an embodiment of the present disclosure showing the selectively removable receptacle of FIG. 50A;

FIG. 50C is a right or left side view of an embodiment of the present disclosure showing the selectively removable receptacle of FIG. 50A with securing elements with the protective film removed;

FIG. 51A is a front view of an embodiment of the present disclosure showing a selectively removable receptacle with securing elements with the protective film removed;

FIG. 51B is a back view of an embodiment of the present disclosure showing the selectively removable receptacle of FIG. 51A with securing elements with the protective film removed;

FIG. 51C is a right or left side view of an embodiment of the present disclosure showing the selectively removable receptacle of FIG. 51A with a securing element with the protective film removed;

FIG. 52A is a front view of an embodiment of the present disclosure showing a selectively removable receptacle with securing elements with the protective film removed;

FIG. 52B is a back view of an embodiment of the present disclosure showing the selectively removable receptacle of FIG. 52A with securing elements with the protective film removed;

FIG. 52C is a right or left side view of an embodiment of the present disclosure showing the selectively removable receptacle of FIG. 52A with a securing element with the protective film removed;

FIG. 53A is a front view of an embodiment of the present disclosure showing a selectively removable receptacle with securing elements with the protective film removed;

FIG. 53B is a back view of an embodiment of the present disclosure showing the selectively removable receptacle of FIG. 53A;

FIG. 53C is a right or left side view of an embodiment of the present disclosure showing the selectively removable receptacle of FIG. 53A with a securing element with the protective film removed;

FIG. 54A is a front view of an embodiment of the present disclosure showing a selectively removable receptacle with a securing element with the protective film removed;

FIG. 54B is a back view of an embodiment of the present disclosure showing the selectively removable receptacle of FIG. 54A;

FIG. 54C is a right or left side view of an embodiment of the present disclosure showing the selectively removable receptacle of FIG. 54A with a securing element with the protective film removed;

FIG. 55A is a front view of an embodiment of the present disclosure showing a selectively removable receptacle with a securing element with the protective film removed;

FIG. 55B is a back view of an embodiment of the present disclosure showing the selectively removable receptacle of FIG. 55A with a securing element with the protective film removed;

FIG. 55C is a right or left side view of an embodiment of the present disclosure showing the selectively removable receptacle of FIG. 55A with a securing element with the protective film removed;

FIG. 55D is a bottom view of an embodiment of the present disclosure showing the selectively removable receptacle of FIG. 55A with a securing element with the protective film removed;

FIG. 56A is a front view of an embodiment of the present disclosure showing a selectively removable receptacle with a securing element with the protective film removed;

FIG. 56B is a back view of an embodiment of the present disclosure showing the selectively removable receptacle of FIG. 56A with a securing element with the protective film removed;

FIG. 56C is a right or left side view of an embodiment of the present disclosure showing the selectively removable receptacle of FIG. 56A with a securing element with the protective film removed;

FIG. 56D is a bottom view of an embodiment of the present disclosure showing the selectively removable receptacle of FIG. 56A with a securing element with the protective film removed;

FIG. 57A is a front view of an embodiment of the present disclosure showing a selectively removable receptacle with securing elements with the protective film removed;

FIG. 57B is a back view of an embodiment of the present disclosure showing the selectively removable receptacle of FIG. 57A with securing elements with the protective film removed;

FIG. 57C is a right or left side view of an embodiment of the present disclosure showing the selectively removable receptacle of FIG. 57A with a securing element with the protective film removed;

FIG. 58A is a front view of an embodiment of the present disclosure showing a selectively removable receptacle with securing element(s) with the protective film removed;

FIG. 58B is a back view of an embodiment of the present disclosure showing the selectively removable receptacle of FIG. 58A with securing element(s) with the protective film removed;

FIG. 58C is a right or left side view of an embodiment of the present disclosure showing the selectively removable receptacle of FIG. 58A with securing element(s) with the protective film removed;

FIG. 59A is a front view of an embodiment of the present disclosure showing a selectively removable receptacle with securing element(s) with the protective film removed;

FIG. 59B is a back view of an embodiment of the present disclosure showing the selectively removable receptacle of FIG. 59A with securing element(s) with the protective film removed;

FIG. 59C is a right or left side view of an embodiment of the present disclosure showing the selectively removable receptacle of FIG. 59A with securing element(s) with the protective film removed;

FIG. 60A is a front view of an embodiment of the present disclosure showing a selectively removable receptacle with securing element(s) with the protective film removed;

FIG. 60B is a back view of an embodiment of the present disclosure showing the selectively removable receptacle of FIG. 60A with securing element(s) with the protective film removed;

FIG. 60C is a right or left side view of an embodiment of the present disclosure showing the selectively removable receptacle of FIG. 60A with securing element(s) with the protective film removed;

FIG. 61A is a front view of an embodiment of the present disclosure showing a selectively removable receptacle with securing element(s) with the protective film removed;

FIG. 61B is a back view of an embodiment of the present disclosure showing the selectively removable receptacle of FIG. 61A;

FIG. 61C is a right or left side view of an embodiment of the present disclosure showing the selectively removable receptacle of FIG. 61A with securing element(s) with the protective film removed;

FIG. 62A is a front view of an embodiment of the present disclosure showing a selectively removable receptacle with securing element(s) with the protective film removed;

FIG. 62B is a back view of an embodiment of the present disclosure showing the selectively removable receptacle of FIG. 62A with securing element(s) with the protective film removed;

FIG. 62C is a right or left side view of an embodiment of the present disclosure showing the selectively removable receptacle of FIG. 62A with securing element(s) with the protective film removed;

FIG. 63A is a front view of an embodiment of the present disclosure showing a selectively removable receptacle with securing element(s) with the protective film removed;

FIG. 63B is a back view of an embodiment of the present disclosure showing the selectively removable receptacle of FIG. 63A;

FIG. 63C is a right or left side view of an embodiment of the present disclosure showing the selectively removable receptacle of FIG. 63A with securing element(s) with the protective film removed;

FIG. 64A is a front view of an embodiment of the present disclosure showing a selectively removable receptacle with securing element(s) with the protective film removed;

FIG. 64B is a back view of an embodiment of the present disclosure showing the selectively removable receptacle of FIG. 64A;

FIG. 64C is a right or left side view of an embodiment of the present disclosure showing the selectively removable receptacle of FIG. 64A with securing element(s) with the protective film removed;

FIG. 65A is a front view of an embodiment of the present disclosure showing a selectively removable receptacle with securing element(s) with the protective film removed;

FIG. 65B is a back view of an embodiment of the present disclosure showing the selectively removable receptacle of FIG. 65A with securing element(s) with the protective film removed;

FIG. 65C is a right or left side view of an embodiment of the present disclosure showing the selectively removable receptacle of FIG. 65A with securing element(s) with the protective film removed;

FIG. 66A is a front view of an embodiment of the present disclosure showing a selectively removable receptacle with securing element(s) with the protective film removed;

FIG. 66B is a back view of an embodiment of the present disclosure showing the selectively removable receptacle of FIG. 66A;

FIG. 66C is a right or left side view of an embodiment of the present disclosure showing the selectively removable receptacle of FIG. 66A with securing element(s) with the protective film removed;

FIG. 67A is a front view of an embodiment of the present disclosure showing a selectively removable receptacle with securing element(s) with the protective film removed;

FIG. 67B is a back view of an embodiment of the present disclosure showing the selectively removable receptacle of FIG. 67A with securing element(s) with the protective film removed;

FIG. 67C is a right or left side view of an embodiment of the present disclosure showing the selectively removable receptacle of FIG. 67A with securing element(s) with the protective film removed;

FIG. 68A is a front view of an embodiment of the present disclosure showing a selectively removable receptacle with securing element(s) with the protective film removed;

FIG. 68B is a back view of an embodiment of the present disclosure showing the selectively removable receptacle of FIG. 68A;

FIG. 68C is a right or left side view of an embodiment of the present disclosure showing the selectively removable receptacle of FIG. 68A with securing element(s) with the protective film removed;

FIG. 69A is a front view of an embodiment of the present disclosure showing a selectively removable receptacle with securing element(s) with the protective film removed;

FIG. 69B is a back view of an embodiment of the present disclosure showing the selectively removable receptacle of FIG. 69A with securing element(s) with the protective film removed;

FIG. 69C is a right or left side view of an embodiment of the present disclosure showing the selectively removable receptacle of FIG. 69A with securing element(s) with the protective film removed;

FIG. 70A is a front view of an embodiment of the present disclosure showing a selectively removable receptacle with securing element(s) with the protective film removed;

FIG. 70B is a back view of an embodiment of the present disclosure showing the selectively removable receptacle of FIG. 70A;

FIG. 70C is a right or left side view of an embodiment of the present disclosure showing the selectively removable receptacle of FIG. 70A with securing element(s) with the protective film removed;

FIG. 71A is a front view of an embodiment of the present disclosure showing a selectively removable receptacle with securing element(s) with the protective film removed;

FIG. 71B is a back view of an embodiment of the present disclosure showing the selectively removable receptacle of FIG. 71A with securing element(s) with the protective film removed;

FIG. 71C is a right or left side view of an embodiment of the present disclosure showing the selectively removable receptacle of FIG. 71A with securing element(s) with the protective film removed;

FIG. 72A is a front view of an embodiment of the present disclosure showing a selectively removable receptacle with securing element(s) with the protective film removed;

FIG. 72B is a back view of an embodiment of the present disclosure showing the selectively removable receptacle of FIG. 72A;

FIG. 72C is a right or left side view of an embodiment of the present disclosure showing the selectively removable receptacle of FIG. 72A with securing element(s) with the protective film removed;

FIG. 73A is a front view of an embodiment of the present disclosure showing a selectively removable receptacle with securing element(s) with the protective film removed;

FIG. 73B is a back view of an embodiment of the present disclosure showing the selectively removable receptacle of FIG. 73A with securing element(s) with the protective film removed;

FIG. 73C is a right or left side view of an embodiment of the present disclosure showing the selectively removable receptacle of FIG. 73A with securing element(s) with the protective film removed;

FIG. 74A is a front view of an embodiment of the present disclosure showing a selectively removable receptacle with securing element(s) with the protective film removed;

FIG. 74B is a back view of an embodiment of the present disclosure showing the selectively removable receptacle of FIG. 74A with securing element(s) with the protective film removed;

FIG. 74C is a right or left side view of an embodiment of the present disclosure showing the selectively removable receptacle of FIG. 74A with securing element(s) with the protective film removed;

FIG. 75A is a front view of an embodiment of the present disclosure showing the selectively removable receptacle with securing element(s) with the protective film removed;

FIG. 75B is a right- or left-side view of an embodiment of the present disclosure showing the selectively removable receptacle of FIG. 75A with securing element(s) with the protective film removed;

FIG. 76A is a front view of an embodiment of the present disclosure showing the selectively removable receptacle with securing element(s) with the protective film removed;

FIG. 76B is a right- or left-side view of an embodiment of the present disclosure showing the selectively removable receptacle of FIG. 76A with securing element(s) with the protective film removed;

FIG. 77A is a side view of an embodiment of the present disclosure showing a purse or a handbag configured to receive the selectively removable receptacle;

FIG. 77B is a top view of an embodiment of the present disclosure of FIG. 77A showing the selectively removable receptacle with securing element(s);

FIG. 78A is a side view of an embodiment of the present disclosure showing a storage cooler or cargo tote configured to receive the selectively removable receptacle; and

FIG. 78B is a top view of an embodiment of the present disclosure of FIG. 78A showing the selectively removable receptacle with securing element(s).

### DETAILED DESCRIPTION

Referring generally to the figures, the present disclosure relates to a receptacle for use in a container that includes at least one securing element that selectively engages a portion of the container.

In certain situations, such as in a bathroom or lavatory, a trash or recycling container may be placed to receive discarded or recyclable items. These items may include used facial tissues, cotton swabs, cotton balls, wipes, for example. Additionally, these items may include used or empty containers of toothpaste, deodorant, makeup, or other toiletries. Often these items are or can be messy, such that they may leave residue or other traces of liquid or solid materials behind once the container is emptied. As the container is often decorative and/or viewed not only by residents but also visitors, having an unsightly or stained container is undesirable.

In other situations, such as a kitchen or food eating area, food waste is often disposed of in one or more containers. One container may be designated for food waste, such that it may be composted or otherwise separated from other types of waste/recycling materials, while another or several containers may be designated for recycling of other products, including those made of paper, glass, and different types of plastic.

All of these containers hold the possibility of receiving items that are messy and prone to leave behind traces of their presence, such as liquids, solids, or a combination thereof. These traces, apart from being unsightly, are also unhygienic and can lead to other unwanted situations developing. These situations can include leaks from the container to the surrounding area, vermin and insects being attracted to the containers, and foul odors from the residue that remains in the container over time.

In addition, containers fouled with messy and otherwise disgusting items necessitate the cleaning of the container to remedy the situation. Often a container needs to be emptied of loose items and debris and/or washed or otherwise cleaned in order to return the container to a safe and sanitary condition. If the container that is fouled is not cleaned and a new receptacle or bag is placed in the container, the enclosed environment may be a breeding ground for foul odors, insects, and other unhealthy conditions.

On occasion, receptacles, such as bags made from plastic or other suitable materials, are used to line, or sleeve inside containers. These bags are often reused or repurposed bags that are collected from other prior uses, such as shopping. In other instances, these bags are specifically designed and purchased for use inside containers, to protect the containers and to “contain” any liquids or solids that may accompany the items placed within the containers-either for recycling or disposal, or both.

However, many bags are not fully suitable for the range of containers. Some bags include a pair of handles, others include integrated drawstrings, and still others have neither. In order for one to use these bags in a plethora of containers, the bag must be adapted, often crudely, to fit the container. In many situations, this leaves at least a portion of the bag visible outside the container, which may be unsightly or unappealing to an otherwise clean and attractive container. In some situations, a bag may be stretched to fit over the container edge or lip, or if the bag is too large, the bag may be tied around the edge of the container. In either situation, the unsightly bag distracts from the appearance of the container and the surrounding area.

According to an embodiment of the disclosure, a receptacle is provided that may be used as a liner for a variety of trash or recycling containers. For example, the receptacle may be used with smaller containers commonly found in bathrooms and offices. While prior receptacles or “bags” are extended over and folded down the sides of their host container, the bags of the present disclosure include one or more securing elements that contact the inside surfaces of the container, holding the bag in place and avoiding the unsightly appearance of a folded-over bag in a container.

The securing elements are positioned in various locations on the outside surface of the bag of the present disclosure. These securing elements may be selectively securable, semi-permanent, or permanent, depending upon the application.

For example, and without limitation, a bathroom garbage container or “can” is often small, such as a 1-2 gallon or 6 liters, approximately. The likely items disposed of in the bathroom garbage can therefore are also small and/or light. These items include facial tissues, toilet paper rolls, paper or plastic cups, cotton swaps, makeup containers, and other bathroom items. As a result, the adhesive portion of a garbage bag for a bathroom may be relatively small, such as a single strip of adhesive place on a portion of the garbage bag.

In one embodiment, the securing elements may be configured as adhesives, such as, but not limited to adhesive tape. In another embodiment, the securing elements may be configured as static-sticker (or “cling”) without using an adhesive. In another embodiment, the securing elements may be configured as hook-and-loop fasteners. In another embodiment, the securing elements may be configured as magnets. In another embodiment, the securing elements may be configured as a combination of those securing elements described herein. In another embodiment, the securing elements may be configured as other mechanical fasteners.

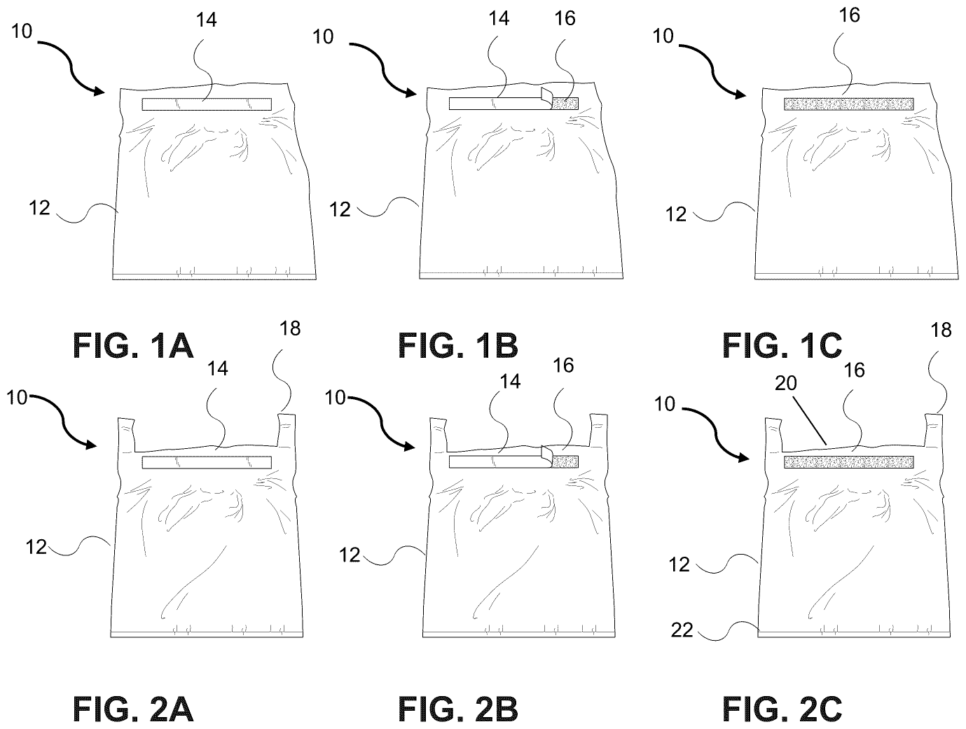

Referring now to the Figures, FIG. 1A illustrates an embodiment of the present disclosure, in which device 10 is shown comprising a bag 12 with an adhesive tape cover 14 disposed near the top of the bag 12, FIG. 1B illustrates bag 12 with a portion of the selectively removable cover 14 is peeled away, revealing a portion of the adhesive 16 exposed to selectively engage a surface of a container, such as a trash bin, particularly but not limited to, the interior surface(s) of the trash bin (not shown). FIG. 1C illustrates the bag 12 with the adhesive 16 fully exposed, the adhesive tape cover 14 having been previously removed. According to this and other embodiments, the adhesive cover 14 protects the adhesive 16 when the device 10 is not in use, such as when it is stored in a box or other vessel storing multiple devices 10, such that the devices 10 will not stick to one another or any other surface until the adhesive cover 14 is removed by a user prior to installation in a trash bin or other suitable container.

FIGS. 2A-2C illustrate another embodiment of the present disclosure, a device 10 including a bag 12 with one or more handles 18. Handles 18 may be used to carry the device 10 as well as perform other tasks, such as aid in closing and/or tying the device 10 when full or otherwise desired by a user. FIGS. 2A-2C also illustrate adhesive cover 14 protecting adhesive 16 until removed by a user for securing to a portion of a container, such the device 10 is secured within a container and not visible on the exterior of the container. Similarly, the device 10 with its adhesive 16 securing the bag 12 to the interior of the container prevents device 10 from sliding down into the bottom of the container when articles and items (trash, etc.) are placed within the container. Device 10 further includes bag opening 20 and bag bottom 22. Bag opening 20 may be configured to allow items to be placed within bag 12 of device 10. Bag bottom 22 may be configured to retain items to be placed within bag 12 of device 10. Bag 12, including adhesive cover 14, adhesive 16, handle(s) 18, bag opening 20 and bag bottom 22 may be configured or constructed using a variety of methods, both known and unknown at the time of this disclosure.

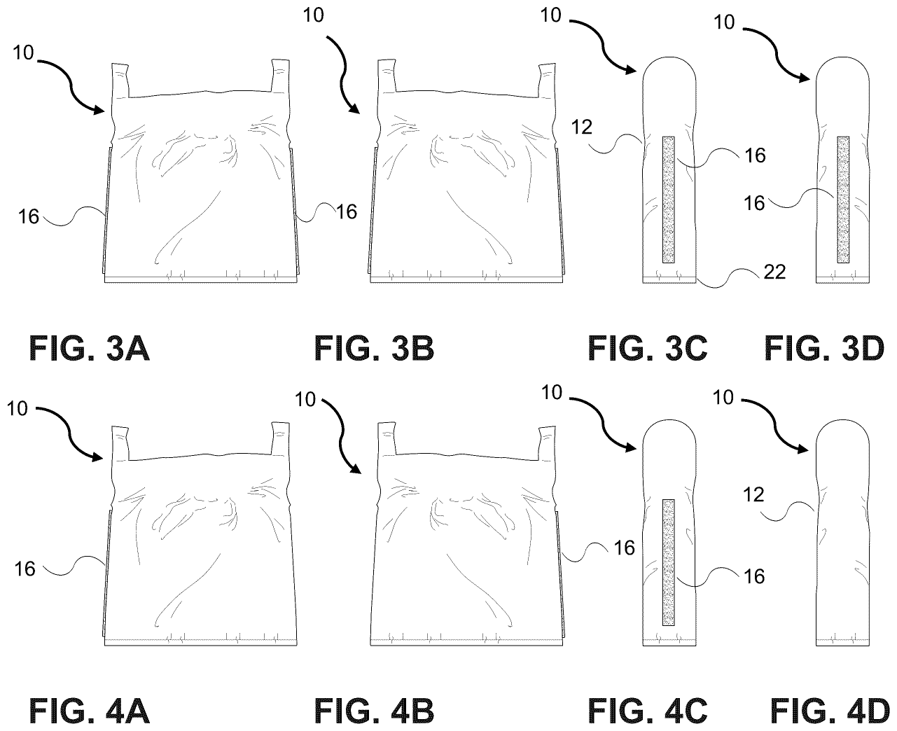

FIGS. 3A-3D illustrate another embodiment of device 10 of the present disclosure. Bag 12 includes a pair of adhesives 16 disposed on both the right and left sides of the bag 12. It should be understood that bag 12 may be configured in a variety of shapes, to conform to containers and/or to be used for other purposes. For example, bag 12 may be configured to be used for shopping, to store purchases and transport them, and then later be used in a trash or recycling container as described herein.

FIGS. 4A-4D illustrate another embodiment of the device 10 of the present disclosure. Bag 12 includes an adhesive 16 disposed on either the right or left side of the bag 12.

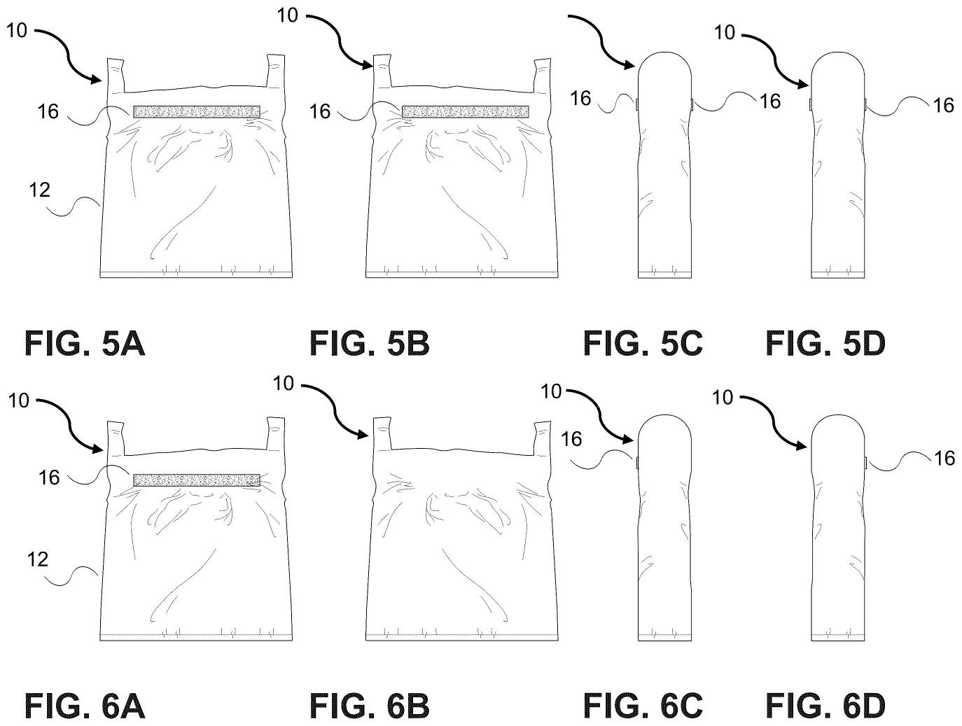

FIGS. 5A-5D illustrate another embodiment of the device 10 of the present disclosure. Bag 12 includes a pair of adhesives 16 disposed on the front or back (rear) upper portion of the bag 12, near the bag opening 20.

FIGS. 6A-6D illustrate another embodiment of the device 10 of the present disclosure. Bag 12 includes an adhesive 16 disposed either the front or back of the upper portion of the bag 12, near the bag opening 20.

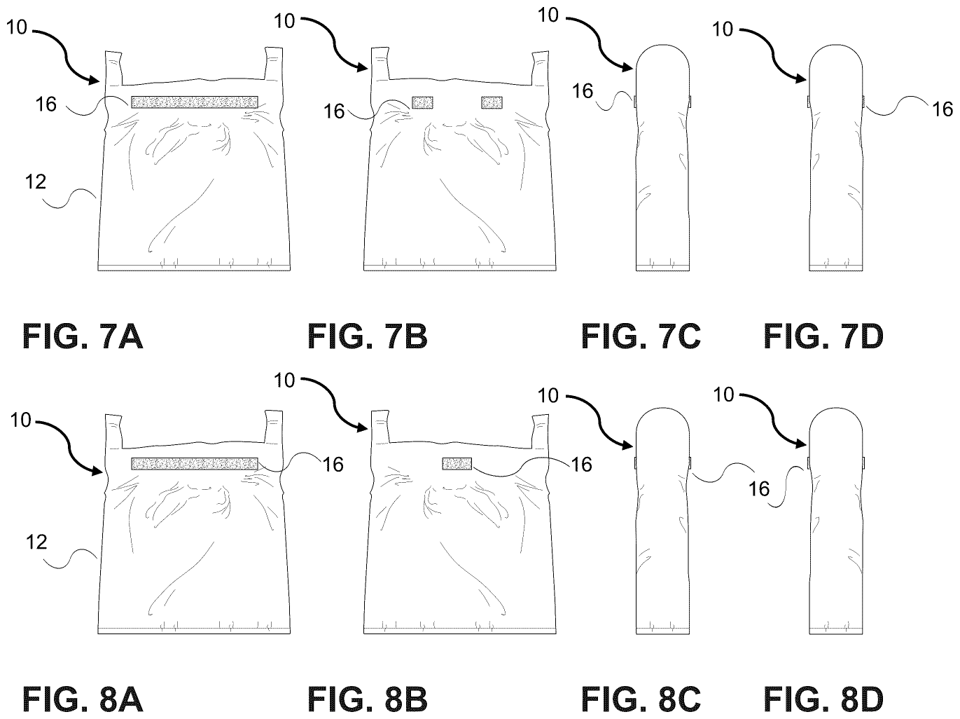

FIGS. 7A-7D illustrate another embodiment of the device 10 of the present disclosure. Bag 12 includes one or more adhesives 16 disposed either the front or back of the upper portion of the bag 12, near the bag opening 20.

FIGS. 8A-8D illustrate another embodiment of the device 10 of the present disclosure. Bag 12 includes one or more adhesives 16 disposed either the front or back of the upper portion of the bag 12, near the bag opening 20.

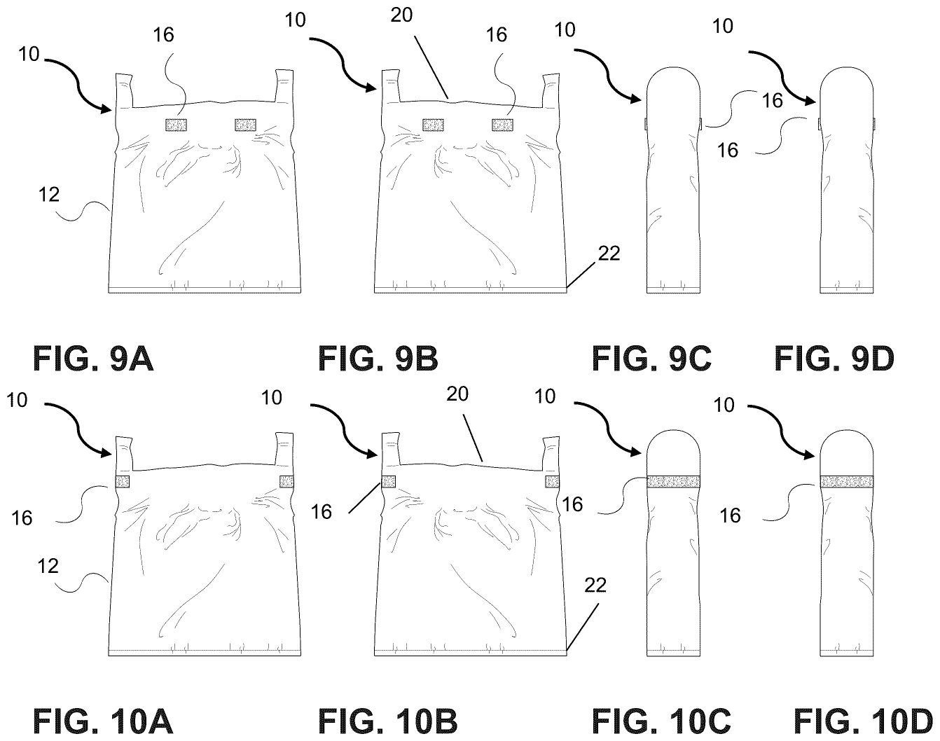

FIGS. 9A-9D illustrate another embodiment of the device 10 of the present disclosure. Bag 12 includes one or more adhesives 16 disposed either the front or back of the upper portion of the bag 12, near the bag opening 20.

FIGS. 10A-10D illustrate another embodiment of the device 10 of the present disclosure. Bag 12 includes one or more adhesives 16 disposed on the edges of the front and back of the bag 12, continuing on the right and left sides, near the bag opening 20.

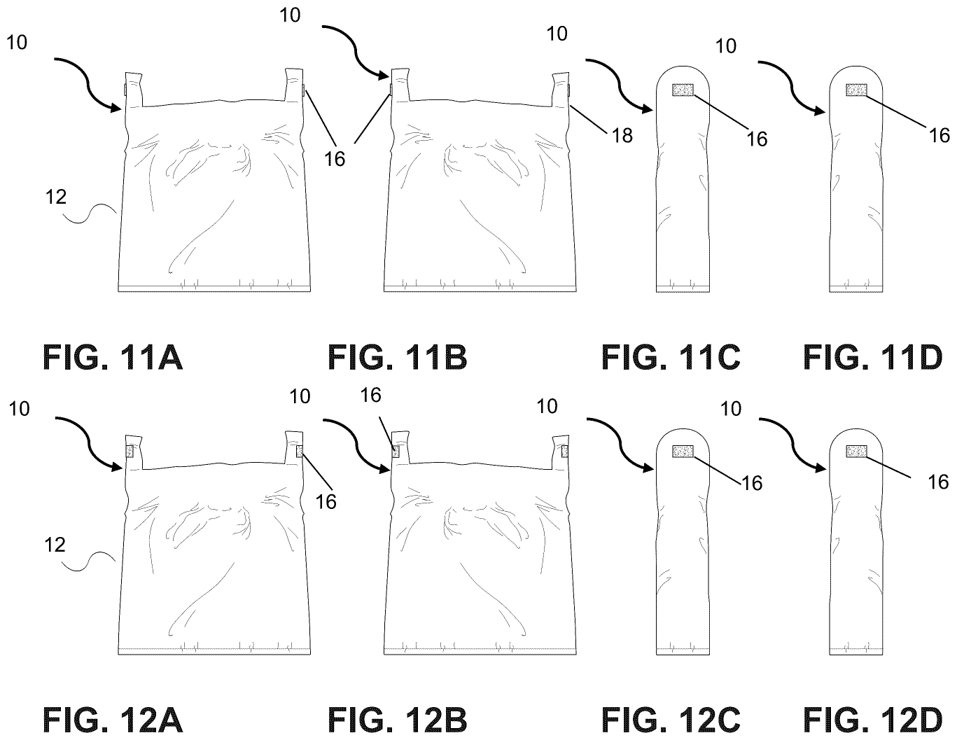

FIGS. 11A-11D illustrate another embodiment of the device 10 of the present disclosure. Bag 12 includes one or more adhesives 16 disposed on the right and left sides of the upper portion of the bag 12, near the handle(s) 18 of bag opening 20.

FIGS. 12A-12D illustrate another embodiment of the device 10 of the present disclosure. Bag 12 includes one or more adhesives 16 disposed on the right and left sides of the upper portion of the bag 12, near the bag opening 20.

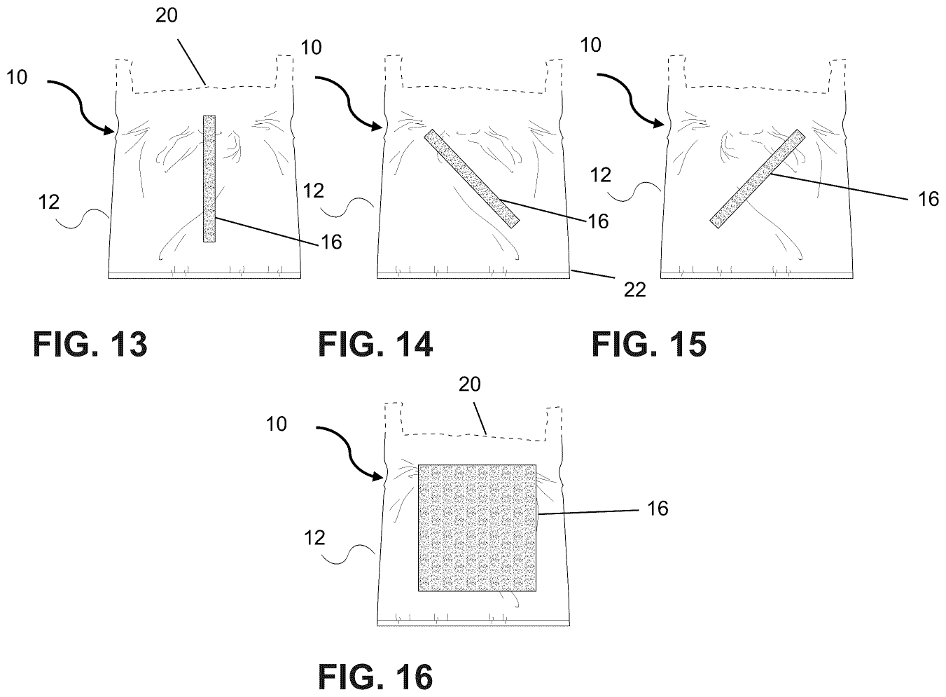

FIG. 13 illustrates another embodiment of the device 10 of the present disclosure. Bag 12 includes an adhesive 16 disposed on either the front of bag 12, or both in a vertical orientation, those other configurations are contemplated.

FIG. 14 illustrates another embodiment of the device 10 of the present disclosure. Bag 12 includes an adhesive 16 disposed on either the front of bag 12, or both in a diagonal orientation.

FIG. 15 illustrates another embodiment of the device 10 of the present disclosure. Bag 12 includes an adhesive 16 disposed on either the front of bag 12, or both in another diagonal orientation.

FIG. 16 illustrates another embodiment of the device 10 of the present disclosure. Bag 12 includes an adhesive 16 disposed on either the front of bag 12, or both configured in a square, though other sizes and shapes are contemplated.

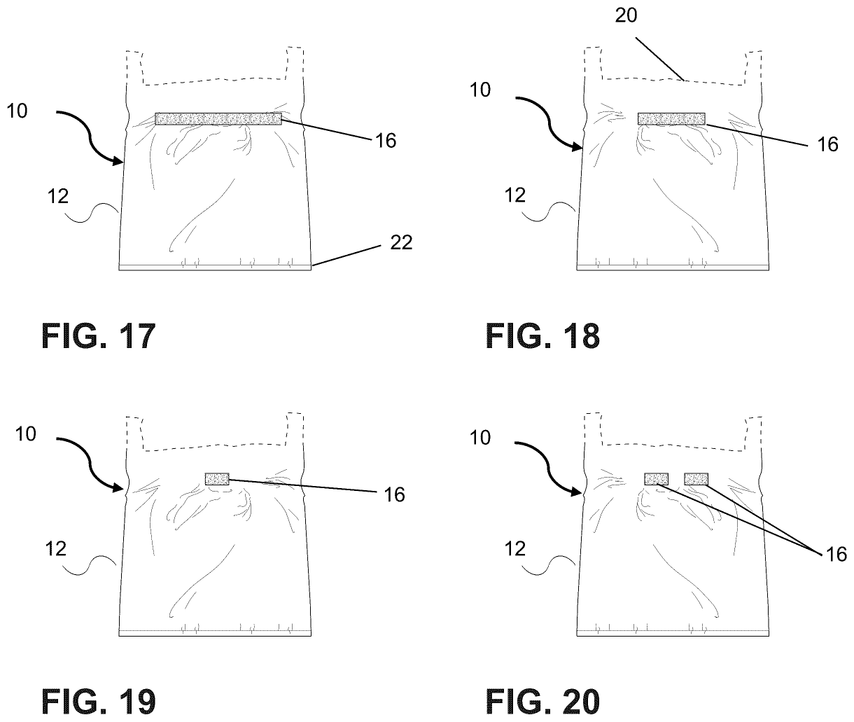

FIG. 17 illustrates another embodiment of the device 10 of the present disclosure. Bag 12 includes an adhesive 16 configured in an elongated rectangular shape disposed at or near the top of the bag 10, near the opening 20.

FIG. 18 illustrates another embodiment of the device 10 of the present disclosure. Bag 12 includes an adhesive 16 configured in an abbreviated rectangular shape disposed at or near the top of the bag 10, near the opening 20.

FIG. 19 illustrates another embodiment of the device 10 of the present disclosure. Bag 12 includes an adhesive 16 configured in a very abbreviated rectangular shape disposed at or near the top of the bag 10, near the opening 20.

FIG. 20 illustrates another embodiment of the device 10 of the present disclosure. Bag 12 includes a pair of adhesives 16 configured in a pair of very abbreviated rectangular shape disposed at or near the top of the bag 10, near the opening 20.

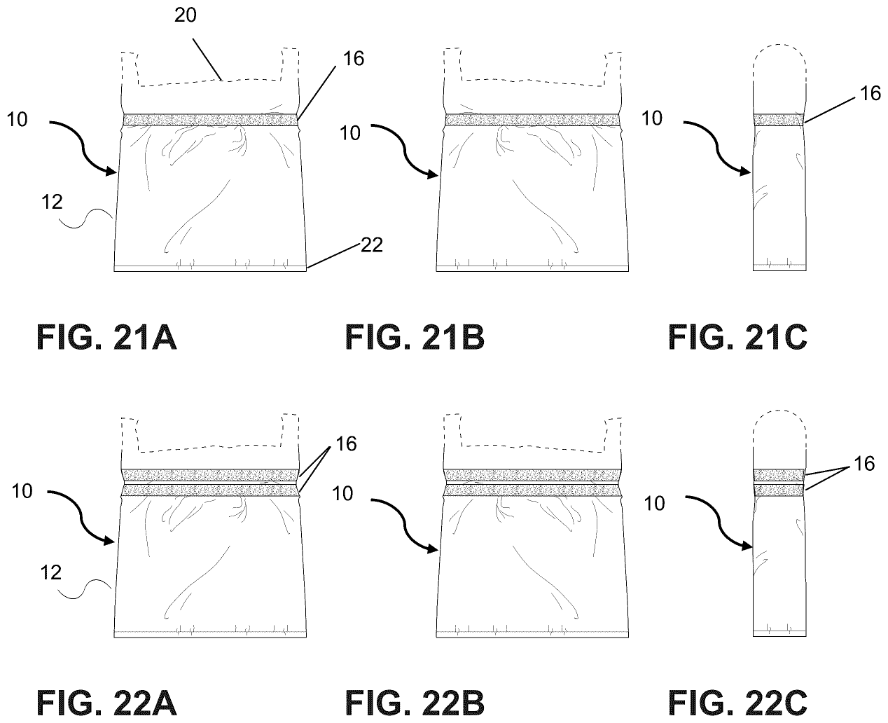

FIGS. 21A-21C illustrate another embodiment of the device 10 of the present disclosure. Bag 12 includes an adhesive 16 configured as a band disposed near the opening 20 of the bag 12 and continuing around the bag 12 on both the right and left sides, and the rear or back of bag 12.

FIGS. 22A-22C illustrate another embodiment of the device 10 of the present disclosure. Bag 12 includes an adhesive 16 configured as a pair of bands disposed near the opening 20 of the bag 12 and continuing around the bag 12 on both the right and left sides, and the rear or back of bag 12.

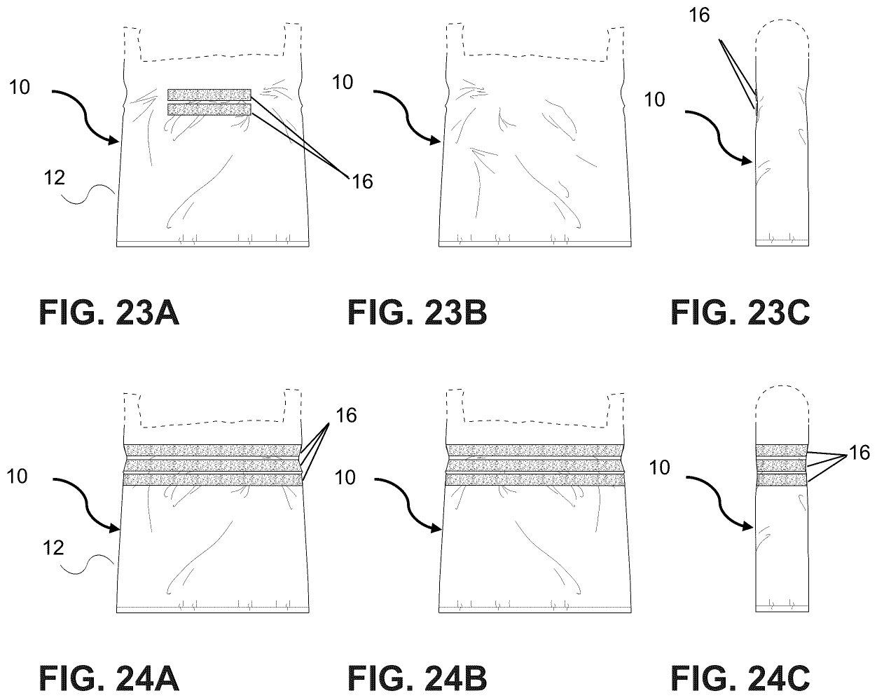

FIGS. 23A-23C illustrate another embodiment of the device 10 of the present disclosure. Bag 12 includes a pair of adhesives 16 configured as parallel rectangles disposed on the front of the bag 12.

FIGS. 24A-24C illustrate another embodiment of the device 10 of the present disclosure. Bag 12 includes a trio of adhesives 16 configured as parallel bands disposed on the front of the bag 12 and continuing on both the right and left sides to the back of bag 12.

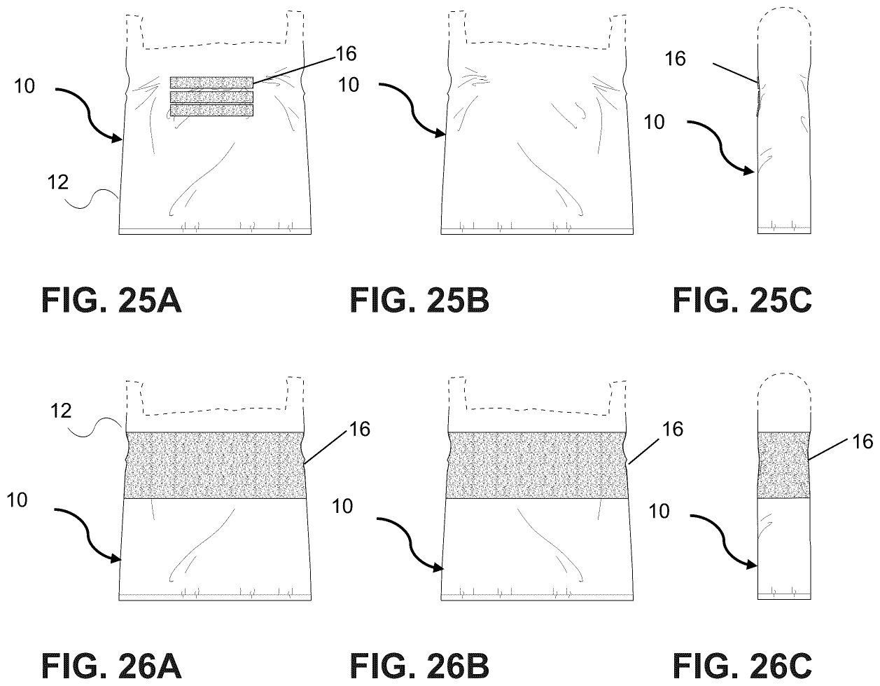

FIGS. 25A-25C illustrate another embodiment of the device 10 of the present disclosure. Bag 12 includes a trio of adhesives 16 configured as parallel bands disposed on the front of the bag 12.

FIGS. 26A-26C illustrate another embodiment of the device 10 of the present disclosure. Bag 12 includes an adhesive 16 configured as a band (or belt) disposed on the front of the bag 12 and continuing on both the right and left sides to the back of bag 12.

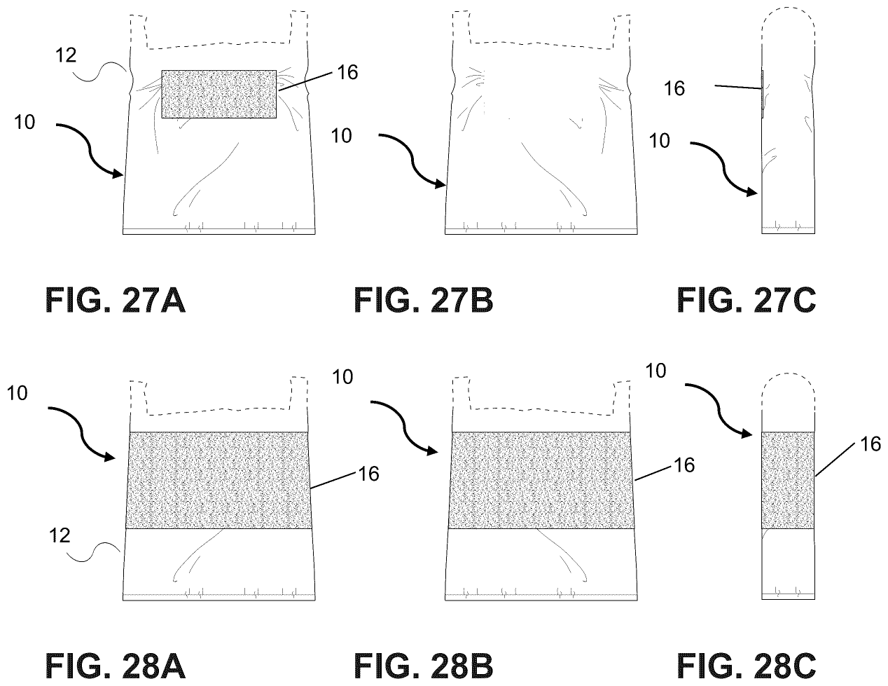

FIGS. 27A-27C illustrate another embodiment of the device 10 of the present disclosure. Bag 12 includes an adhesive 16 configured as a rectangle disposed on the front of the bag 12.

FIGS. 28A-28C illustrate another embodiment of the device 10 of the present disclosure. Bag 12 includes an adhesive 16 configured as a rectangle disposed on the front of the bag 12 and continuing on both the right and left sides to the back of bag 12.

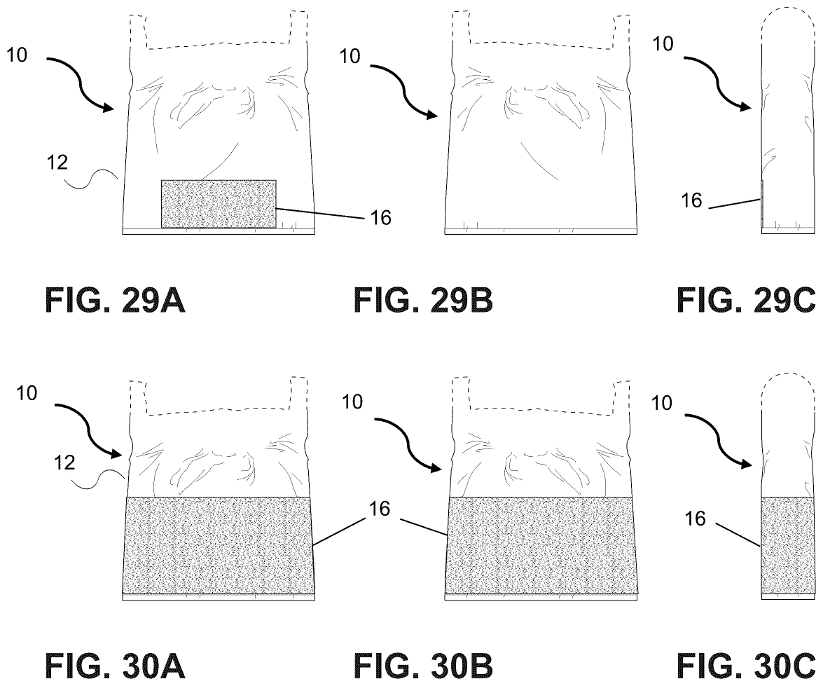

FIGS. 29A-29C illustrate another embodiment of the device 10 of the present disclosure. Bag 12 includes an adhesive 16 configured as a rectangle disposed on the front of the bag 12 near the bag bottom 22.

FIGS. 30A-30C illustrate another embodiment of the device 10 of the present disclosure. Bag 12 includes an adhesive 16 configured as a band or belt disposed on the front of the bag 12 near the bag bottom 22.

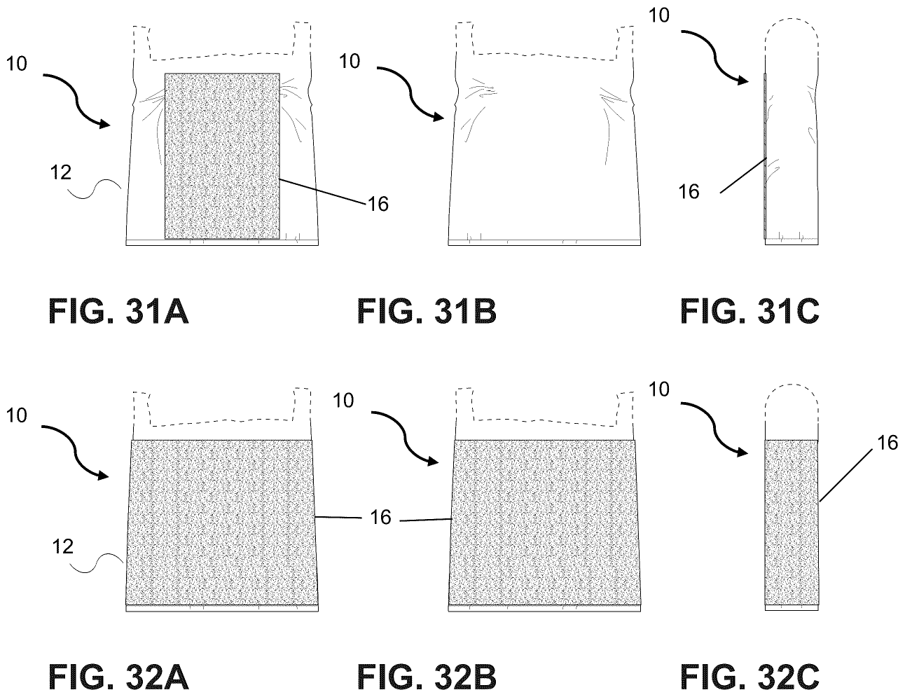

FIGS. 31A-31C illustrate another embodiment of the device 10 of the present disclosure. Bag 12 includes an adhesive 16 configured as a rectangle disposed on the front of the bag 12 near both the bag opening 20 and the bag bottom 22.

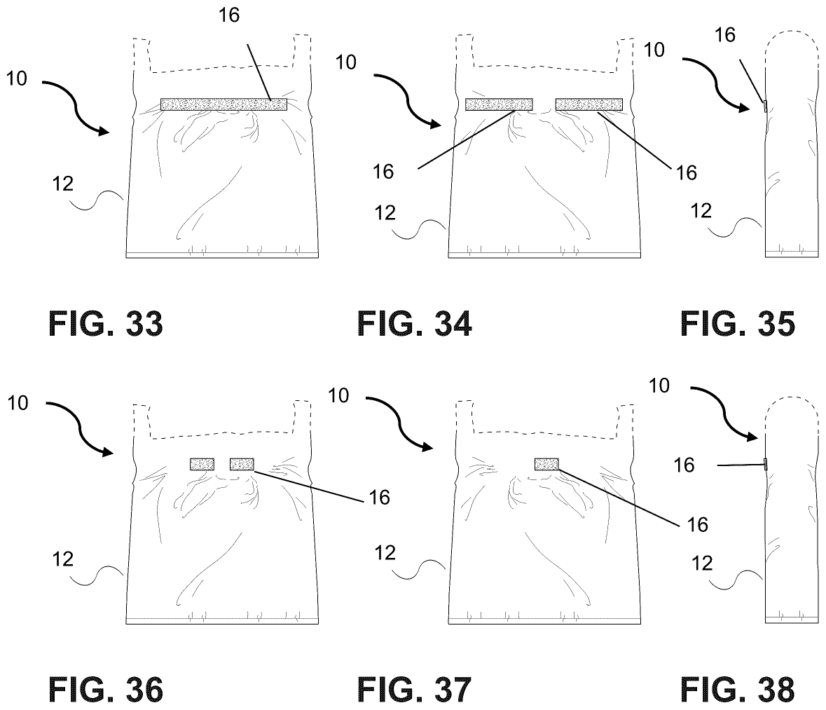

FIGS. 32A-32C illustrate another embodiment of the device 10 of the present disclosure. Bag 12 includes an adhesive 16 configured as a band or belt disposed on the front of the bag 12 near both the bag opening 20 and the bag bottom 22.

FIG. 33 illustrates another embodiment of the device 10 of the present disclosure. Bag 12 includes an adhesive 16 configured as a rectangle disposed on the front of bag 12, near bag opening 20.

FIG. 34 illustrates another embodiment of the device 10 of the present disclosure. Bag 12 includes a pair of adhesives 16 configured as rectangle disposed on the front of bag 12, near bag opening 20.

FIG. 35 illustrates another embodiment of the device 10 of the present disclosure, including FIGS. 33 and 34. Bag 12 includes one or more adhesives 16 disposed on the front of bag 12, near bag opening 20.

FIG. 36 illustrates another embodiment of the device 10 of the present disclosure. Bag 12 includes a pair of adhesives 16 configured as rectangle disposed on the front of bag 12, near bag opening 20.

FIG. 37 illustrates another embodiment of the device 10 of the present disclosure. Bag 12 includes an adhesive 16 configured as rectangle disposed on the front of bag 12, near bag opening 20.

FIG. 38 illustrates another embodiment of the device 10 of the present disclosure, including FIGS. 36 and 37. Bag 12 includes one or more adhesives 16 disposed on the front of bag 12, near bag opening 20.

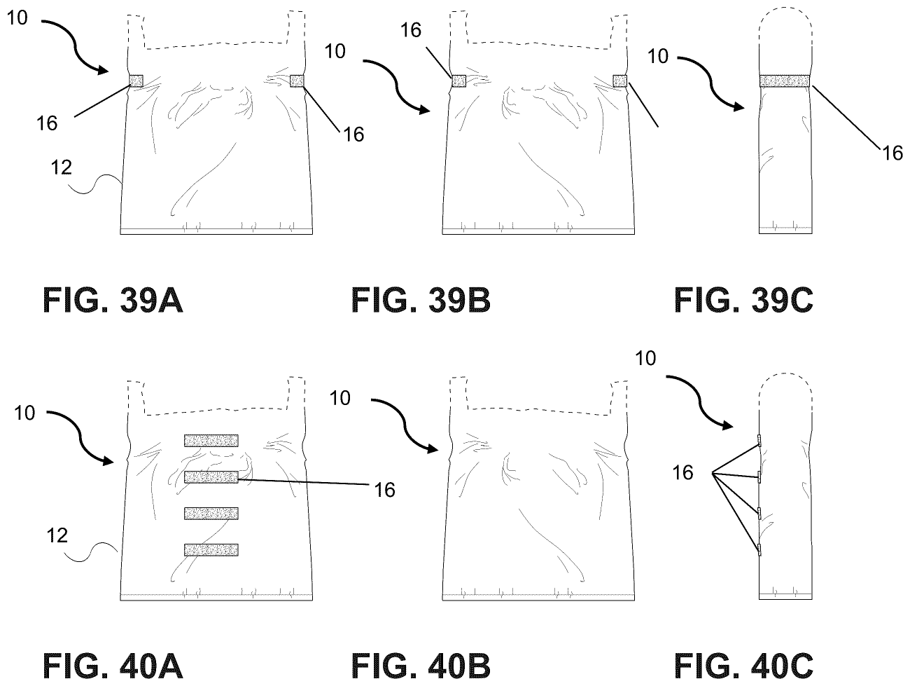

FIGS. 39A-39C illustrate another embodiment of the device 10 of the present disclosure. Bag 12 includes a pair of adhesives 16 disposed on the sides of the bag 12 near the bag opening 20.

FIGS. 40A-40C illustrate another embodiment of the device 10 of the present disclosure. Bag 12 includes a plurality of adhesives 16 configured as parallel rectangles disposed on the front of the bag 12.

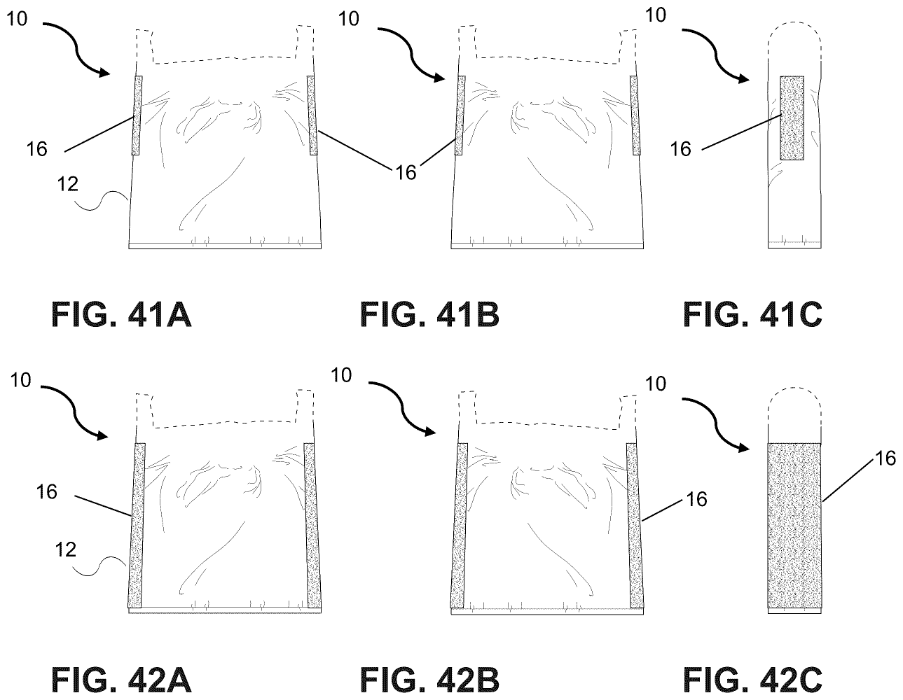

FIGS. 41A-41C illustrate another embodiment of the device 10 of the present disclosure. Bag 12 includes a pair of adhesives 16 configured as rectangles disposed on the sides of the bag 12.

FIGS. 42A-42C illustrate another embodiment of the device 10 of the present disclosure. Bag 12 includes a pair of adhesives 16 configured as elongated rectangles disposed on the sides of the bag 12.

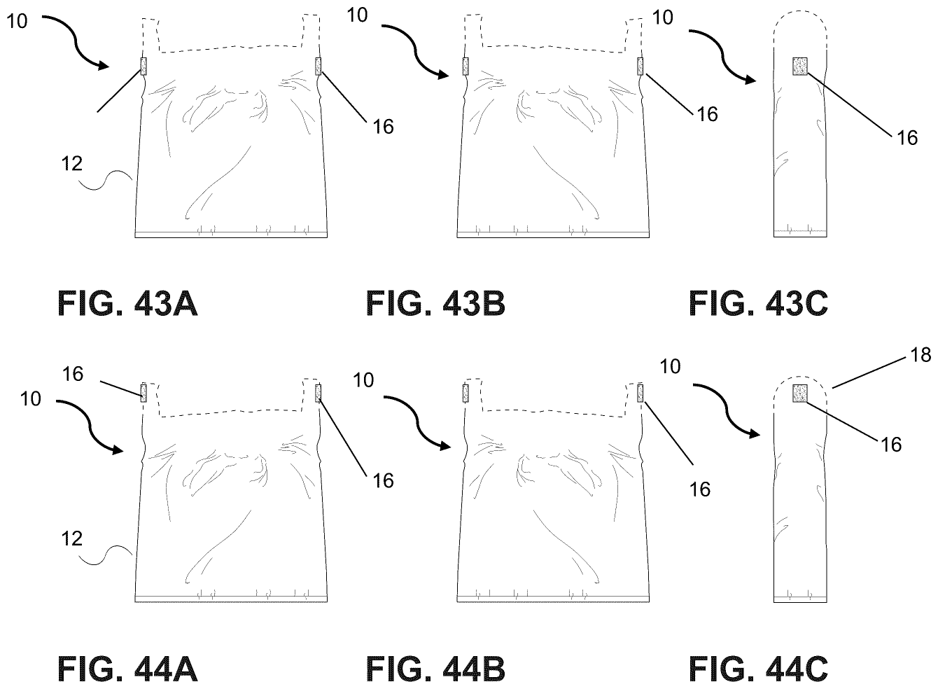

FIGS. 43A-43C illustrate another embodiment of the device 10 of the present disclosure. Bag 12 includes a pair of adhesives 16 configured as squares disposed on the sides of the bag 12, near the bag opening 20.

FIGS. 44A-44C illustrate another embodiment of the device 10 of the present disclosure. Bag 12 includes a pair of adhesives 16 configured as squares disposed on the sides of the bag 12, near the bag opening 20.

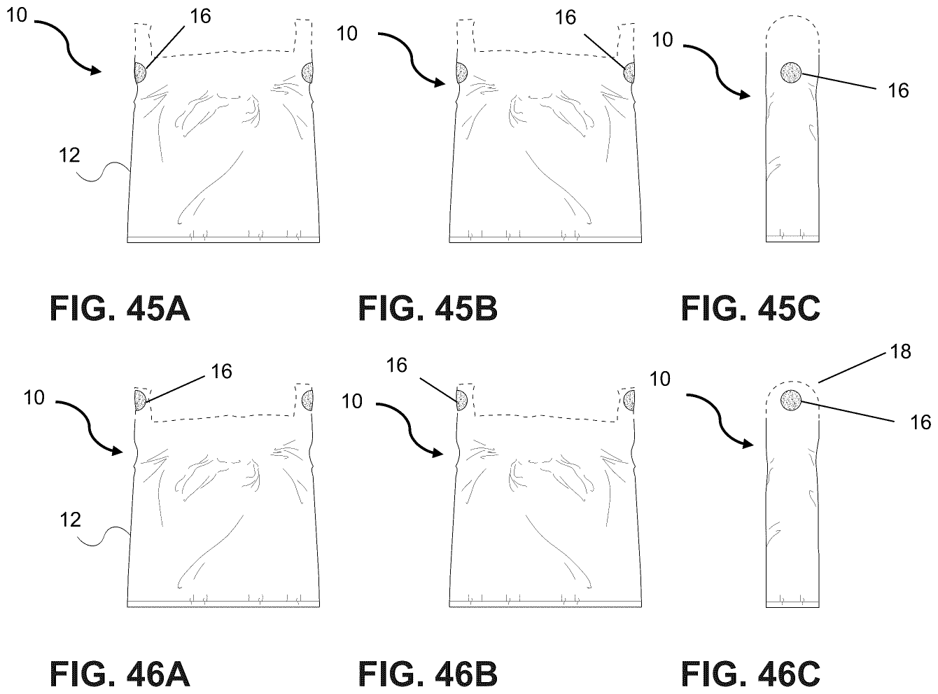

FIGS. 45A-45C illustrate another embodiment of the device 10 of the present disclosure. Bag 12 includes a pair of adhesives 16 configured as circles disposed on the sides of the bag 12, near the bag opening 20.

FIGS. 46A-46C illustrate another embodiment of the device 10 of the present disclosure. Bag 12 includes a pair of adhesives 16 configured as circles disposed on the sides of the bag 12, near the handle(s) 18 and the bag opening 20.

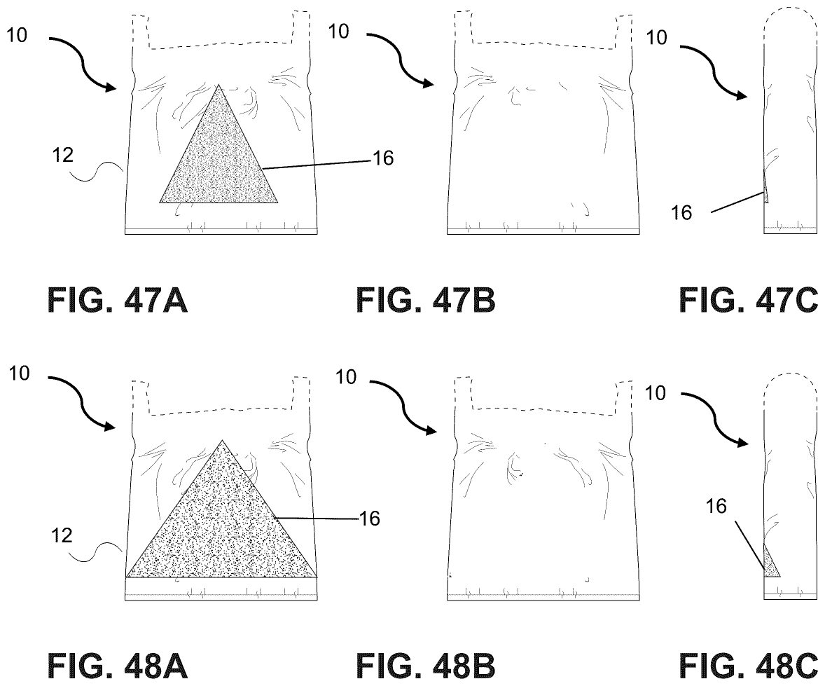

FIGS. 47A-47C illustrate another embodiment of the device 10 of the present disclosure. Bag 12 includes an adhesive 16 configured as a triangle disposed on the front of the bag 12.

FIGS. 48A-48C illustrate another embodiment of the device 10 of the present disclosure. Bag 12 includes an adhesive 16 configured as a triangle disposed on the front of the bag 12, with a portion of the adhesive triangle 16 wrapping over onto the sides of the bag 12.

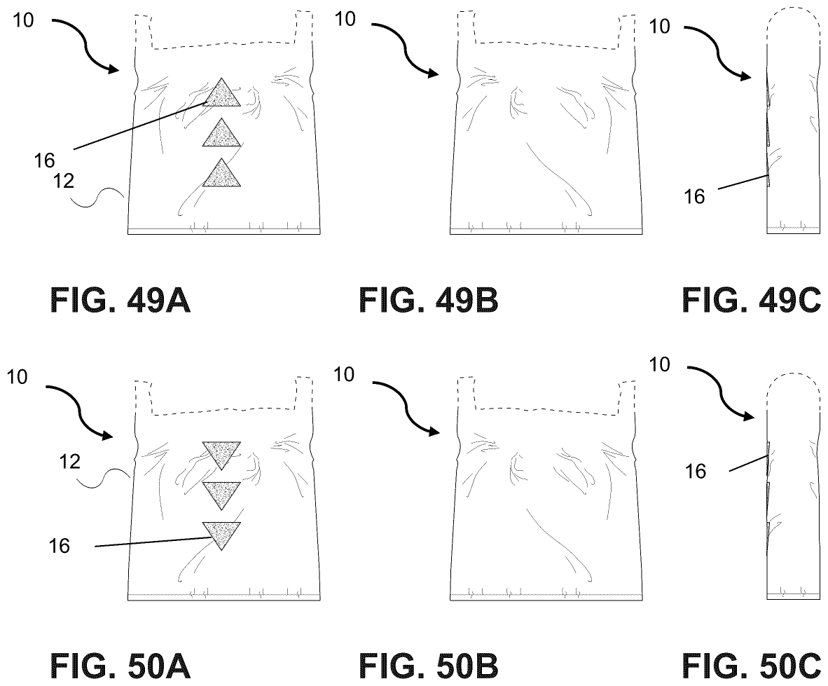

FIGS. 49A-49C illustrate another embodiment of the device 10 of the present disclosure. Bag 12 includes a plurality of adhesives 16 configured as triangles disposed on the front of the bag 12.

FIGS. 50A-50C illustrate another embodiment of the device 10 of the present disclosure. Bag 12 includes a plurality of adhesives 16 configured as inverted triangles disposed on the front of the bag 12.

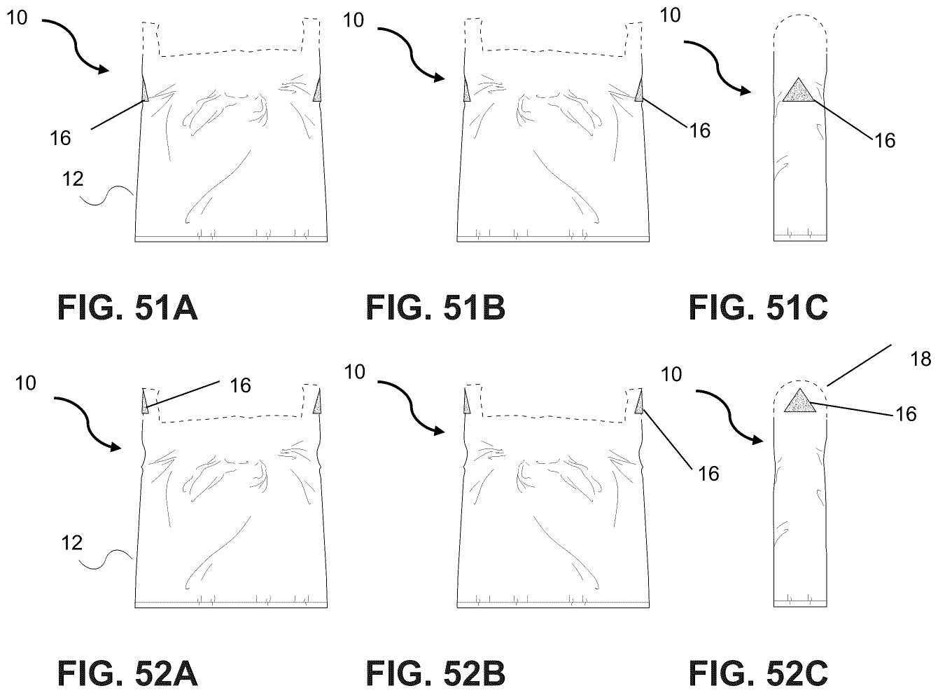

FIGS. 51A-51C illustrate another embodiment of the device 10 of the present disclosure. Bag 12 includes a pair of adhesives 16 configured as triangles disposed on the sides of the bag 12.

FIGS. 52A-52C illustrate another embodiment of the device 10 of the present disclosure. Bag 12 includes a pair of adhesives 16 configured as triangles disposed on the sides of the bag 12, near the handle(s) 18.

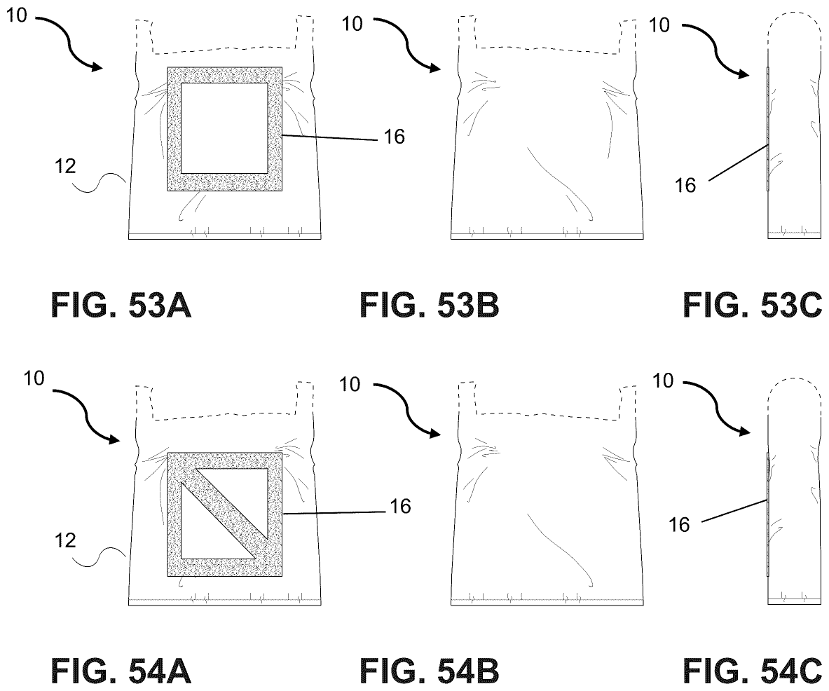

FIGS. 53A-53C illustrate another embodiment of the device 10 of the present disclosure. Bag 12 includes an adhesive 16 configured as a concentric square disposed on the front of the bag 12.

FIGS. 54A-54C illustrate another embodiment of the device 10 of the present disclosure. Bag 12 includes an adhesive 16 configured as a concentric square having a diagonal disposed on the front of the bag 12.

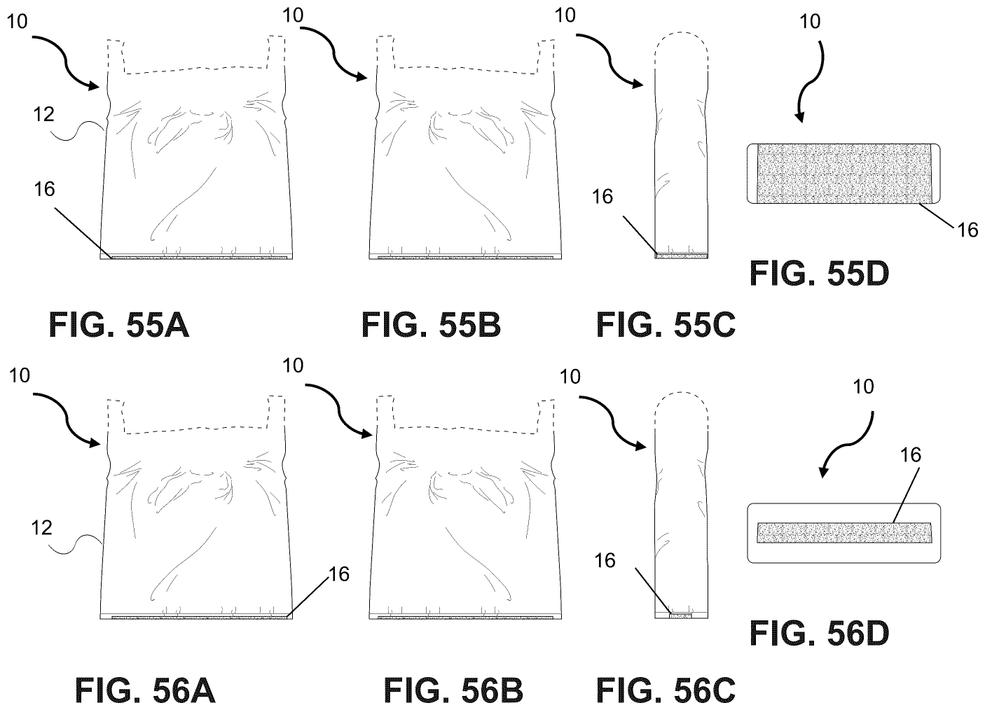

FIGS. 55A-55D illustrate another embodiment of the device 10 of the present disclosure. Bag 12 includes an adhesive 16 configured as a rectangle disposed on the bag bottom 22 of the bag 12.

FIGS. 56A-56D illustrate another embodiment of the device 10 of the present disclosure. Bag 12 includes an adhesive 16 configured as a thin rectangle disposed on the bag bottom 22 of the bag 12.

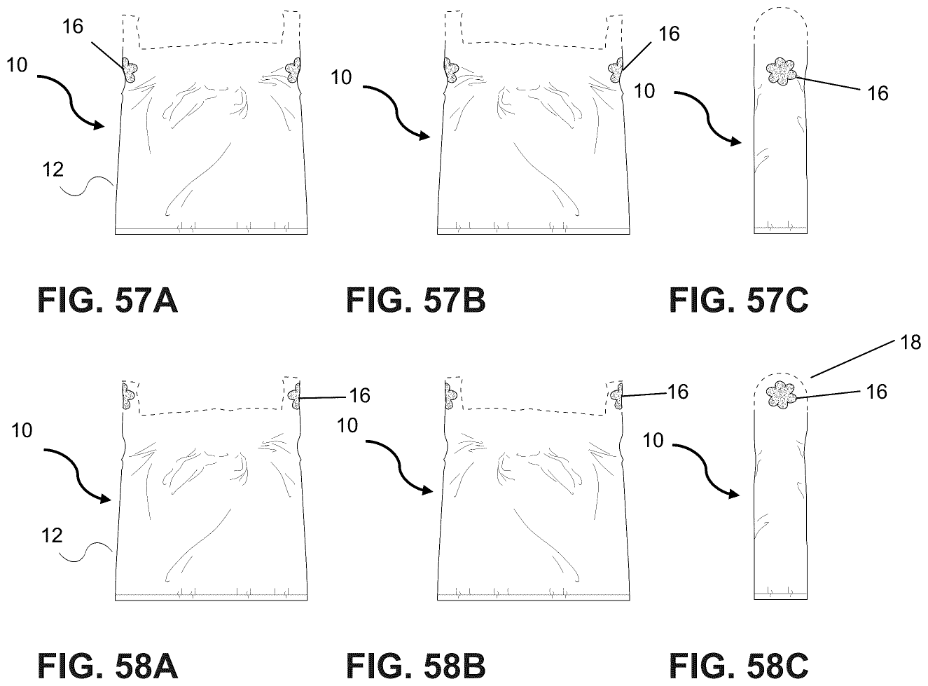

FIGS. 57A-57C illustrate another embodiment of the device 10 of the present disclosure. Bag 12 includes a pair of adhesives 16 configured as a flower disposed on the right and left sides of the bag 12.

FIGS. 58A-58C illustrate another embodiment of the device 10 of the present disclosure. Bag 12 includes a pair of adhesives 16 configured as a flower disposed on the right and left sides of the bag 12 near the handle(s) 18.

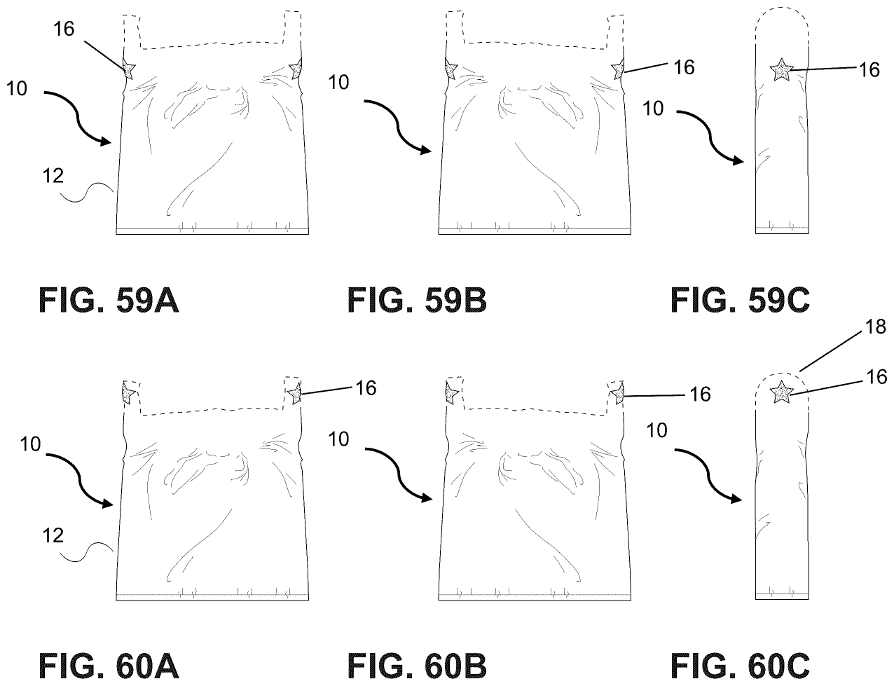

FIGS. 59A-59C illustrate another embodiment of the device 10 of the present disclosure. Bag 12 includes a pair of adhesives 16 configured as a star disposed on the right and left sides of the bag 12.

FIGS. 60A-60C illustrate another embodiment of the device 10 of the present disclosure. Bag 12 includes a pair of adhesives 16 configured as a flower disposed on the right and left sides of the bag 12 near the handle(s) 18.

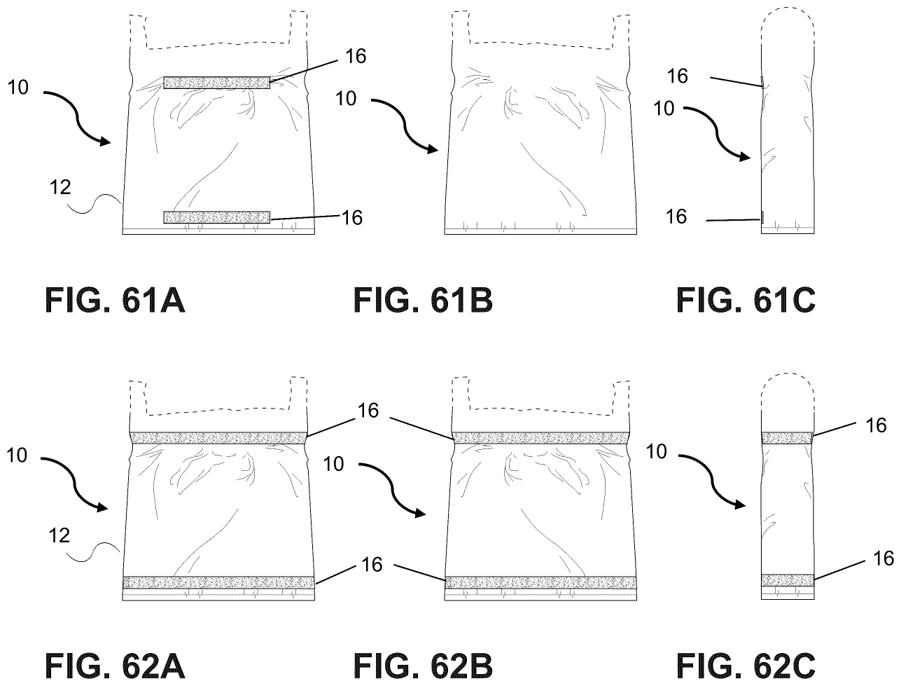

FIGS. 61A-61C illustrate another embodiment of the device 10 of the present disclosure. Bag 12 includes a pair of adhesives 16 configured as rectangles, one disposed on the front, near the bag opening 20 and the other near the bag bottom 22 of bag 12.

FIGS. 62A-62C illustrate another embodiment of the device 10 of the present disclosure. Bag 12 includes a pair of adhesives 16 configured as bands or belts, one disposed on the front, near the bag opening 20 and the other near the bag bottom 22, wrapping around bag 12.

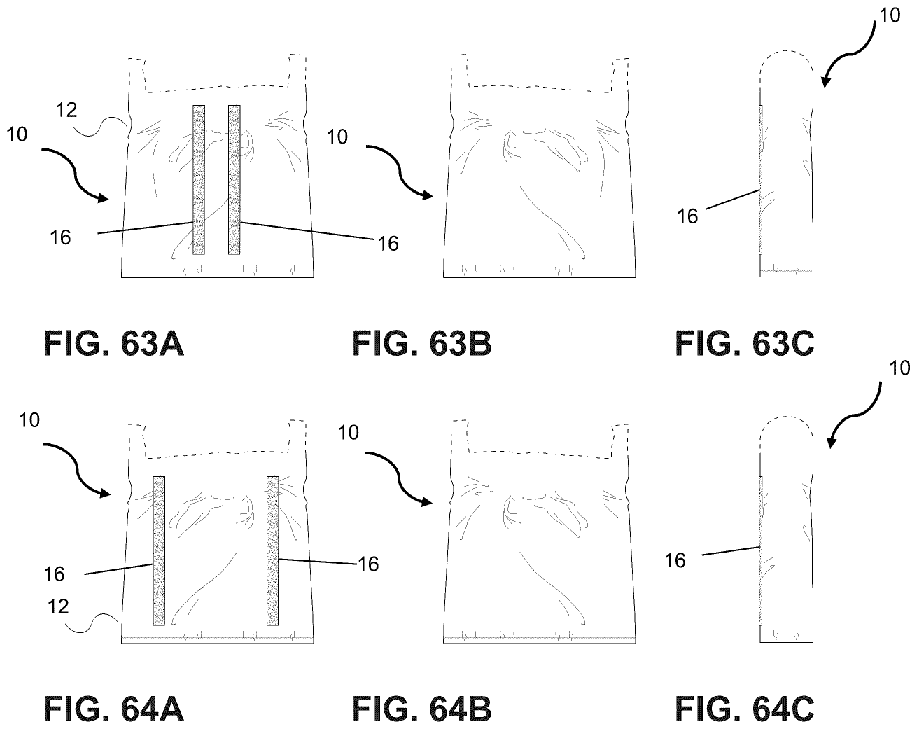

FIGS. 63A-63C illustrate another embodiment of the device 10 of the present disclosure. Bag 12 includes a pair of adhesives 16 configured as vertical rectangles disposed near the center of the front of the bag 12.

FIGS. 64A-64C illustrate another embodiment of the device 10 of the present disclosure. Bag 12 includes a pair of adhesives 16 configured as vertical rectangles disposed near the sides of the front of the bag 12.

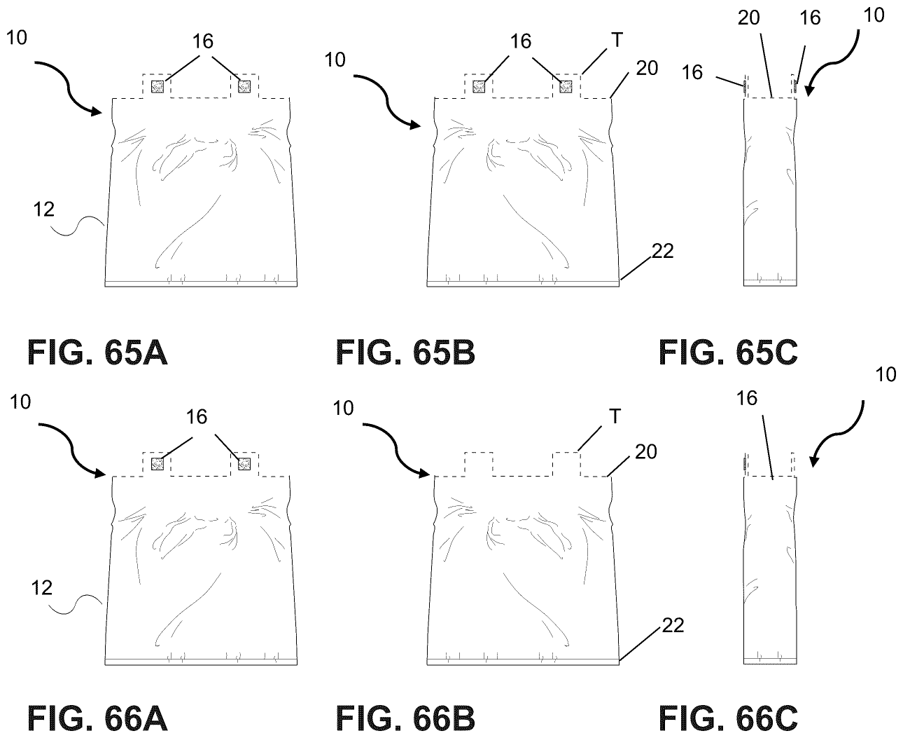

FIGS. 65A-65C illustrate another embodiment of the device 10 of the present disclosure. Bag 12 includes a pair of adhesives 16 configured as squares disposed on tabs T near the bag opening 20 on the front and back sides of the bag 12.

FIGS. 66A-66C illustrate another embodiment of the device 10 of the present disclosure. Bag 12 includes a pair of adhesives 16 configured as squares disposed on tabs T near the bag opening 20 on the front side of the bag 12.

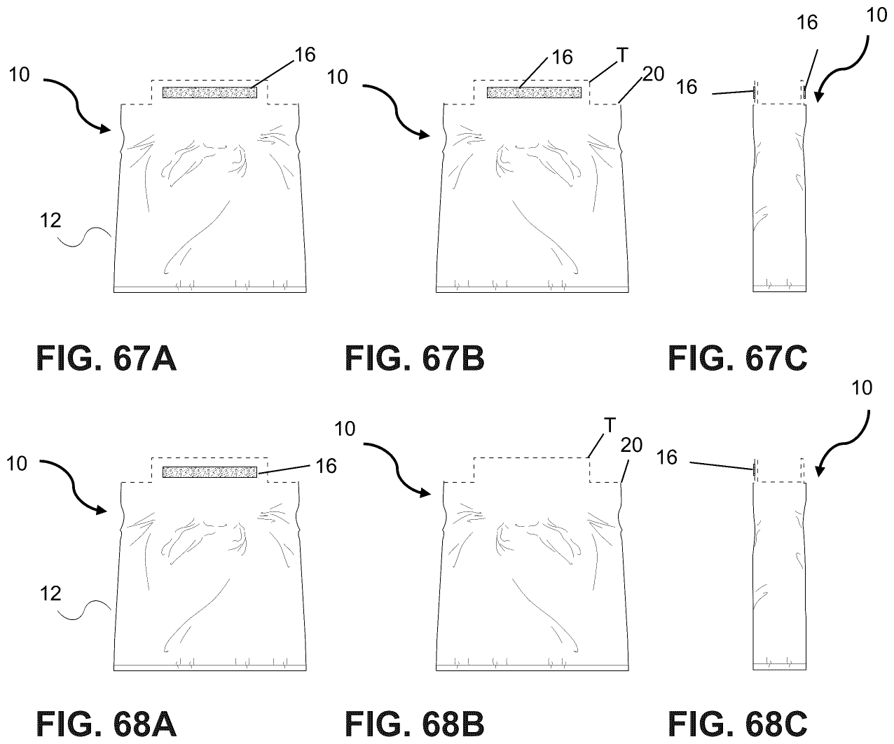

FIGS. 67A-67C illustrate another embodiment of the device 10 of the present disclosure. Bag 12 includes a pair of adhesives 16 configured as rectangles disposed on outer side of tabs T near the bag opening 20 on the front and back sides of the bag 12.

FIGS. 68A-68C illustrate another embodiment of the device 10 of the present disclosure. Bag 12 includes an adhesive 16 configured as a rectangle disposed on outer side of tab T near the bag opening 20 on the front side of the bag 12.

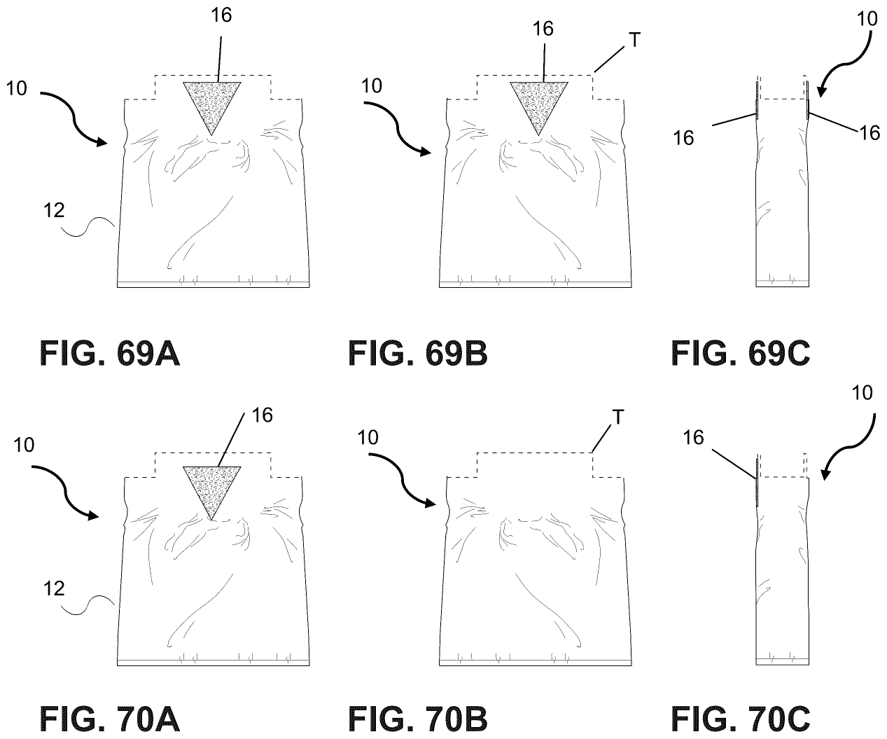

FIGS. 69A-69C illustrate another embodiment of the device 10 of the present disclosure. Bag 12 includes a pair of adhesives 16 configured as triangles disposed on outer side of tabs T near the bag opening 20 on the front and back sides of the bag 12.

FIGS. 70A-70C illustrate another embodiment of the device 10 of the present disclosure. Bag 12 includes an adhesive 16 configured as a triangle disposed on outer side of tab T near the bag opening 20 on the front side of the bag 12.

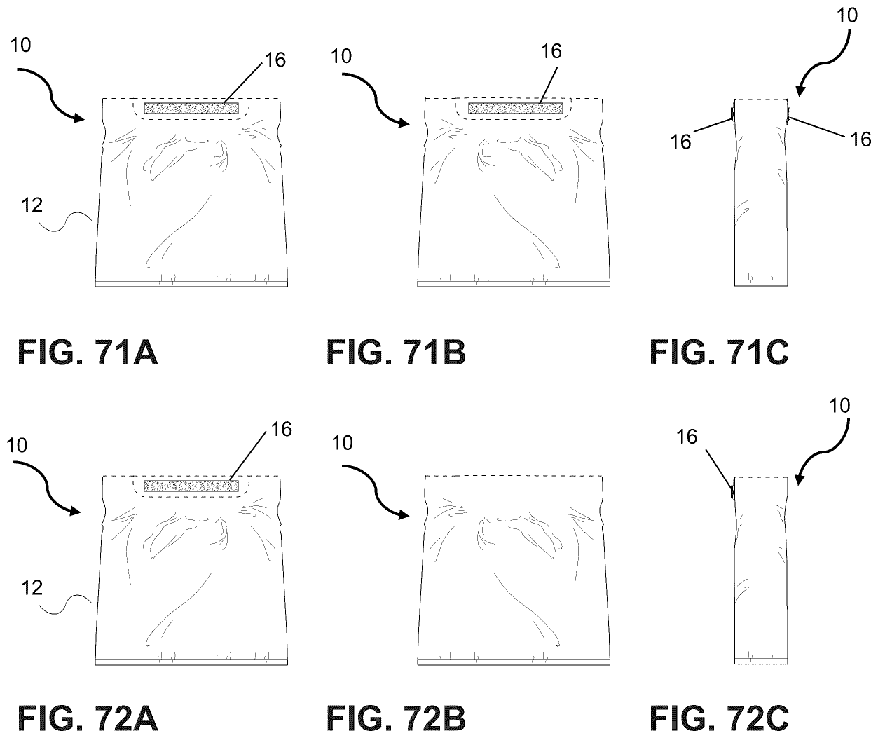

FIGS. 71A-71C illustrate another embodiment of the device 10 of the present disclosure. Bag 12 includes a pair of adhesives 16 detachably configured as rectangles disposed near the bag opening 20 on the front side of the bag 12.

FIGS. 72A-72C illustrate another embodiment of the device 10 of the present disclosure. Bag 12 includes an adhesive 16 detachably configured as a rectangle disposed near the bag opening 20 on the front side of the bag 12.

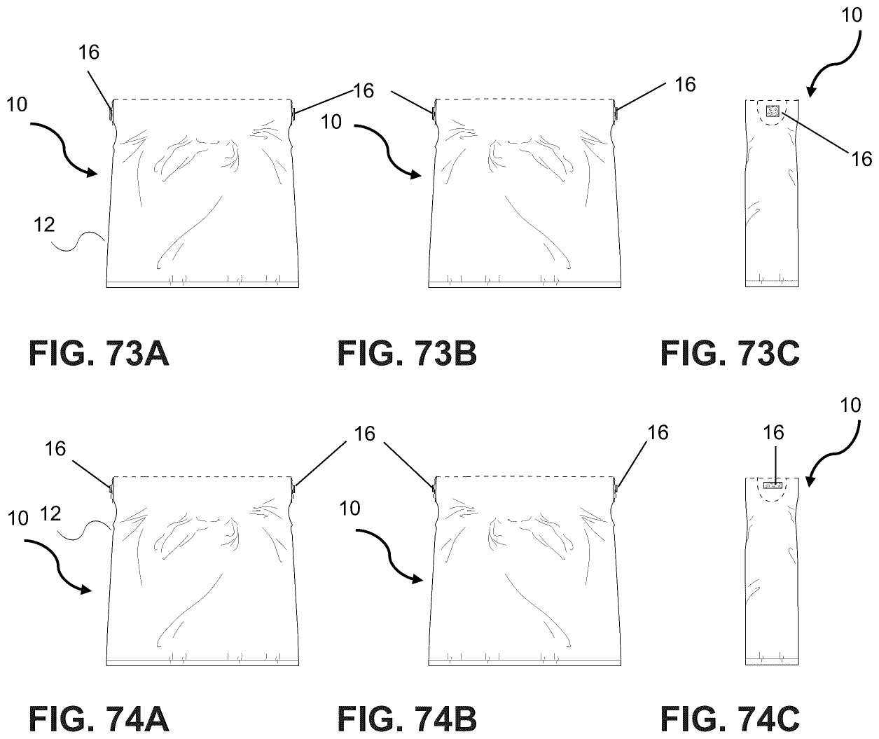

FIGS. 73A-73C illustrate another embodiment of the device 10 of the present disclosure. Bag 12 includes a pair of adhesives 16 detachably configured as squares disposed on the sides of the bag 12.

FIGS. 74A-74C illustrate another embodiment of the device 10 of the present disclosure. Bag 12 includes a pair of adhesives 16 detachably configured as rectangles disposed on the sides of the bag 12.

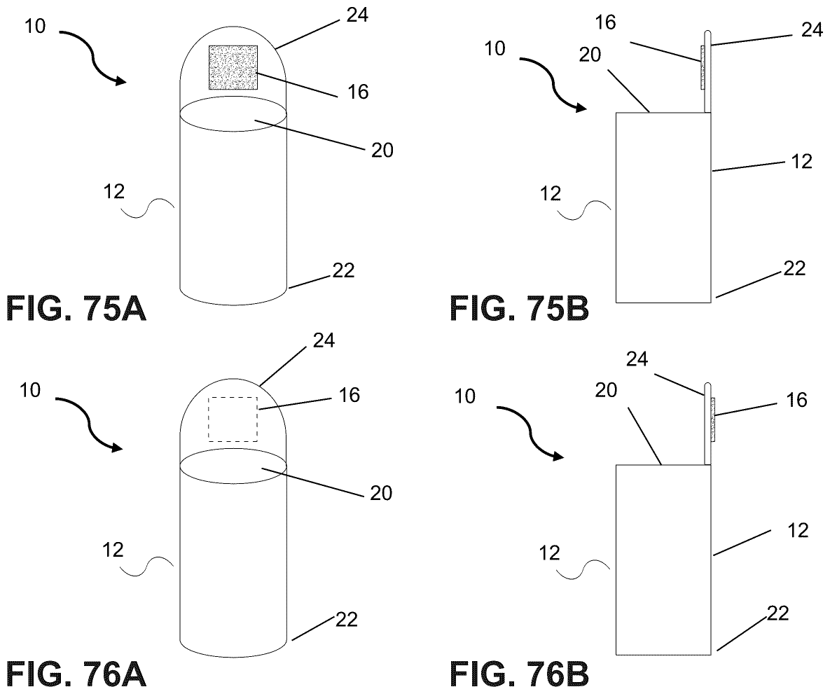

FIGS. 75A-75B illustrate another embodiment of the device 10 of the present disclosure. Bag 12 includes an adhesive 16 disposed adjacent to bag opening 20 and opposite bag bottom 22 on the interior-facing side of lid 24. Lid 24 is hingeably attached to the bag 12 adjacent to the bag opening 20.

FIGS. 76A-76B illustrate another embodiment of the device 10 of the present disclosure. Bag 12 includes an adhesive 16 disposed adjacent to bag opening 20 and opposite bag bottom 22 on the exterior-facing side of lid 24. Lid 24 is hingeably attached to the bag 12 adjacent to the bag opening 20.

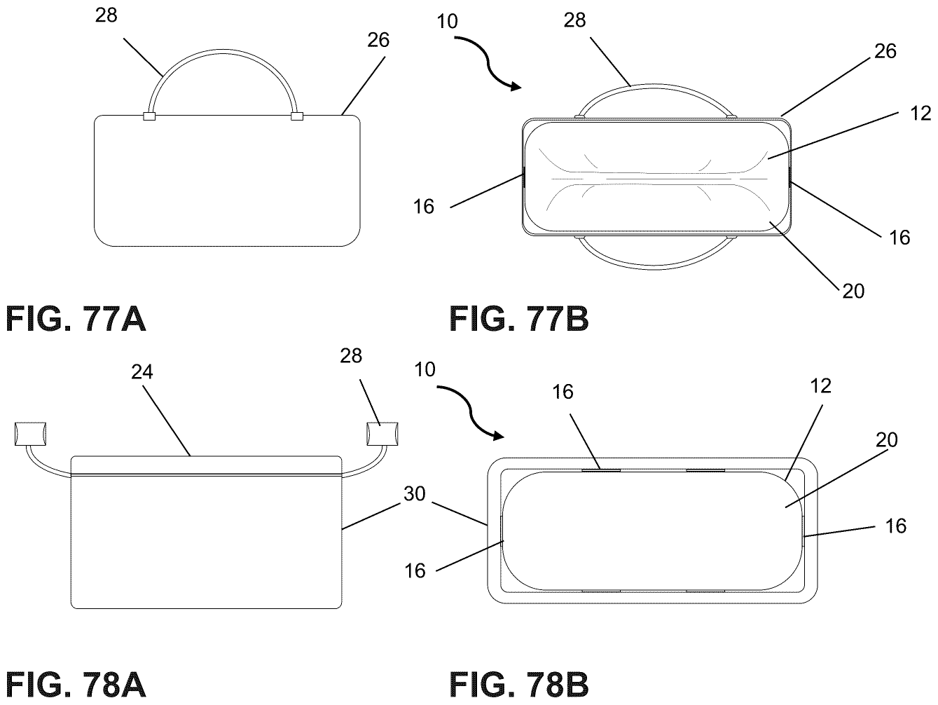

FIGS. 77A-77B illustrate another embodiment of the device 10 of the present disclosure, for use in a handbag or purse 26, for example. Bag 12 is shown with a pair of adhesives 16 disposed adjacent to the interior surfaces of the purse 26 having one or more grab handles 28 and bag opening 20 extends into the interior of the purse 26.

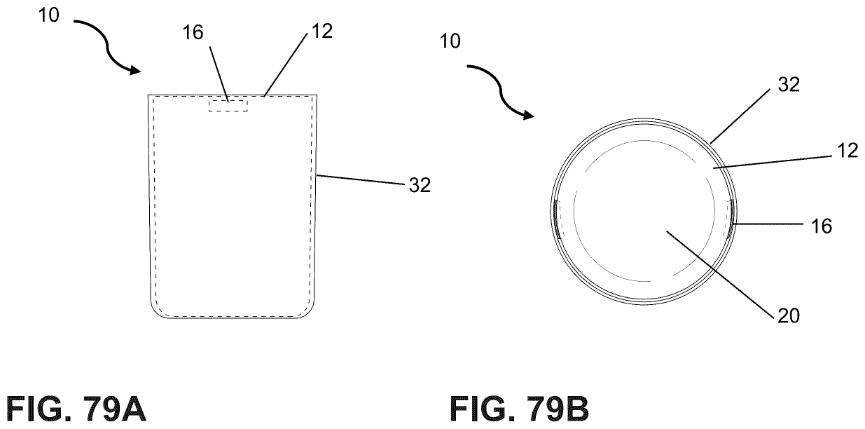

FIGS. 78A-78B illustrate another embodiment of the device 10 of the present disclosure, for use in a cooler or ice chest 30 having one of more grab handles 28, for example. Bag 12 is shown with a plurality of adhesives 16 disposed around the perimeter of bag 12 to selectively engage the interior surfaces of the ice chest 30.

FIGS. 79A-79B illustrate another embodiment of the device 10 of the present disclosure, in this example, shown with a trash bin or container 32. Bag 12 is shown placed inside container 32 with one or more adhesives 16 selectively engaging the interior surface(s) of the container 32, holding the bag 12 in place within the container 32. Bag opening 20 is shown to receive items and/or articles placed within bag 12 located within container 32 such that the weight of the items placed within bag 12 will not pull the bag 12 down into the container 32, as adhesives 16 selectively and securely prevent bag 12 from being pulled down into the container 32.

In embodiments, the bag includes at least one adhesive portion that may be configured as an adhesive, tape, or other sticky material. The adhesive portion is configured to engage the interior of the container to maintain the affixed position of the bag within the container. One advantage to the adhesive portion of the bag is that it allows the bag to remain hidden within in the container and so allows the container to have an enhanced appearance as opposed to a bag without adhesive that is often draped over the edge of the container and down the outside of the container.

The adhesive portion may be configured in a variety of shapes and sizes. The adhesive portion may be configured depending upon the size of the container and/or the likely contents.

In one embodiment, the securing elements may be configured as adhesives, such as, but not limited to adhesive tape. The tape may be configured to be two-sided, such that one side bonds or sticks to the bag while the other side sticks to the interior of the container, concealing the bag from being seen “draped” over the top rim and/or down the exterior of the container. The two-sided tape may be configured in different strengths. In other words, the adhesive strength on the bag/device side may be stronger than the adhesive strength on the refuse container side. In this configuration, a user may easily install and remove the device/bag from the container while the adhesive remains attached to the device/bag.

In another embodiment, the securing elements may be configured as spray adhesive or glue. In place of a pre-formed or geometrically-shaped adhesive, a spray-on glue may be used. A securing film may be placed over the spray glue or the layering of the bags in a retail box may act as a film, such that removing the first bag from the retail box may expose the glue of the bag underneath, or that removing the first bag with a film exposes the spray glue of subsequent bags. Further still, the bags may be layers in manufacturer such that each bag is folded over itself or another bag, providing an airtight or relatively airtight seal for the spray glue. This configuration may be used for other embodiments described herein, and is not limiting.

In another embodiment, the securing elements may be configured as static-sticker (or “cling”) without using an adhesive. A static-sticker or “cling” is a relatively sticky film that allows a user to remove or separate items but also provides a relatively strong attachment due to the properties of the cling and the mating surfaces-in this case the device of the present disclosure and a refuse bin or trash can. The cling may allow a user to adjust and/or repeatedly attach and detach the device/bag from the container, such as to empty, reuse, or otherwise replace or reposition.

In another embodiment, the securing elements may be configured as hook-and-loop fasteners. A hook-and-loop fastener (H&L), sometimes known by the trade name of one manufacturer as Velcro® may be used instead or together with adhesives or other securing elements described herein. Using H&L, additional strength may be provided to retain the bag device inside the trash bin. This may be particularly helpful when larger bags are used, such as for recyclable containers or large volumes of trash and/or food waste. The H&L may allow for the reuse or reposition of the device bag inside the bin.

In another embodiment, the securing elements may be configured as magnets. Magnets may be integrated with the bag devices and be attracted to metallic portions or sections of a trash bin to aid in securing the bag device inside the container.

In another embodiment, the securing elements may be configured as other mechanical fasteners. Hooks, snaps, and other mechanical devices may be used alone or with other securing elements described herein.

In another embodiment, the securing elements may be configured as a combination of those securing elements described herein.

The present disclosure is further directed to receptacles having structural variations and alternative securing mechanisms, as well as applications of such receptacles across a broader array of use cases beyond household waste, including commercial, industrial, and specialty applications. These additions are intended to support utility patent claims of broader scope and durability in examination.

In one embodiment, the securing elements are located on tab extensions that protrude from the main body of the receptacle, such that the securing elements remain physically separated from the primary bag body until applied. These tab-mounted adhesives or fasteners may be folded inward or outward to conceal or expose the securing element prior to or after installation. This configuration improves adhesion surface alignment while permitting the bag to maintain a minimal profile when packaged.

In another embodiment, the securing elements include magnets configured to couple to a metal or magnetically receptive surface of the inner container. The magnets may be enclosed in flexible or semi-rigid polymer pockets to prevent direct exposure and provide alignment with the container wall. These pockets may be welded or bonded to the exterior surface of the bag, either directly or via protruding flaps. The magnets may be shaped as discs, bars, or flexible sheets and are preferably embedded near the top portion of the bag to resist downward slippage when the bag is filled. Tab-mounted magnets may optionally allow for edge wrapping around a container lip.

In another embodiment, hook-and-loop fasteners are used as the securing element. A loop patch may be bonded to an outer surface of the bag, and the hook component may be supplied separately or pre-installed in the waste container. The loop patches may be rectangular, square, or arcuate and are preferably disposed near the upper front, back, or side panels of the bag. In some versions, tab extensions are used to mount the hook or loop pads to allow flexibility and contact with curved or irregular container walls. The bag may be installed by pressing the fastener regions into place against the corresponding hook surfaces.

In other embodiments, static cling film may be laminated or selectively applied to the bag exterior. These surfaces generate temporary adhesion to smooth plastic or glass inner container walls without using chemical adhesives. Static cling zones may be disposed on large surface areas, such as side panels or integrated belts, and may be activated by flattening and pressing the surface to the container with hand pressure. These regions may be printed or tinted to guide the user.

The receptacle may also include mechanical fasteners such as snaps, tabs, or interlocking flanges. These elements may be configured as part of a custom insertable bag frame or collar, with one half of the fastener affixed to the bag body and the other to a complementary structure mounted inside the container. In embodiments using press-fit ridges or tongue-and-groove seals, the fasteners are positioned near the bag's rim and allow a removable but secure engagement with a rigid liner or bin adapter.

In some configurations, the receptacle is further provided with color-coded or indicia-marked adhesive or fastening zones, such as visual guides that indicate peel direction, application orientation, or adhesion strength. For example, a red-colored film may signal high-adhesion zones near the top rim, while a blue-colored tab may indicate secondary adhesion sites near the bottom or sides.

In certain embodiments, the receptacle is provided as part of a kit that includes an installation guide and applicator. The installation guide may be a printed card, label, or insert that provides written instructions and diagrams showing the recommended bag positioning, securing element alignment, and installation steps. In some versions, the installation guide may be printed directly onto the packaging or onto the bag itself using water-resistant ink.

The applicator may be a simple handheld pressing tool, such as a flexible squeegee, roller, or tab activator, that helps the user evenly apply pressure along the securing element to ensure proper adhesion or fastening to the container wall. Alternatively, the applicator may comprise a peel-assist tab or fixture that aids in the removal of a protective film from an adhesive strip. In embodiments where hook-and-loop fasteners are used, the applicator may include a template or guide surface that helps align the hook patch with the loop pad installed in the container.

The receptacle may also be manufactured using compostable materials, including biodegradable plastics, fiber composites, or recycled materials. The adhesive or fastening materials may likewise be formulated to comply with compostable or non-toxic certification standards.

In still other embodiments, the securing elements are integrated into decorative or structural elements of the bag, such as embossments, printed zones, or flanged seams. The function of concealment, anchoring, and non-intrusive visual appearance remains integral across all embodiments.

The receptacle may be provided in a kit, with a roll or stack of bags, each having integrated securing elements. The kit may further include an applicator tool, installation guide, or container adapter inserts.

The present disclosure contemplates configurations wherein the receptacle is adapted for specific non-trash uses, such as: (a) laundry receptacles in public washrooms, (b) bag-in-box fluid storage, (c) receptacles in medical, veterinary, or hazardous material settings where leakproof, concealed, or stable placement is critical, and (d) event or travel contexts where temporary but secure and concealed placement of disposable bags is desirable.

All variations, modifications, and combinations of the disclosed securing mechanisms, shapes, materials, and deployment methods are considered within the scope of the invention.

All variations, modifications, and combinations of the disclosed securing mechanisms, shapes, materials, and deployment methods are considered within the scope of the invention.

The preceding examples illustrate embodiments of the disclosure, but should not be viewed as limiting the scope of the disclosure.

Other embodiments and uses of the disclosure will be apparent to those skilled in the art from consideration of the specification and practice of the disclosure disclosed herein. All references cited herein, including all publications, U.S. and foreign patents and patent applications, are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the disclosure indicated by the following claims.

1. A receptacle for receiving waste or recyclable items, comprising:
a bag having a front panel, a back panel, and opposing side edges, the bag defining an opening and a bottom; and
at least one securing element affixed to an exterior surface of the bag, the securing element comprising an adhesive material configured to selectively adhere to an interior surface of a container such that the bag is retained in place within the container and concealed from external view during use.

2. The receptacle of claim 1, wherein the adhesive material is positioned near the opening of the bag.

3. The receptacle of claim 1, wherein the adhesive material is covered by a removable protective film prior to use.

4. The receptacle of claim 1, wherein the adhesive material comprises a pressure-sensitive adhesive strip extending across at least 50% of the bag width.

5. The receptacle of claim 1, wherein the bag includes a pair of opposing adhesive elements disposed on lateral sides of the bag.

6. The receptacle of claim 1, wherein the adhesive element is color-coded to indicate location or strength.

7. The receptacle of claim 1, wherein the adhesive is a repositionable adhesive adapted for multiple applications.

8. The receptacle of claim 1, wherein the bag comprises a biodegradable material and the adhesive is compostable.

9. A receptacle comprising:
a flexible bag defining an opening and a closed bottom; and
a plurality of securing elements disposed at distinct vertical positions on an outer surface of the bag, the securing elements each comprising an adhesive, magnetic, or mechanical fastener configured to anchor the bag at more than one point to an inner container wall to resist slippage during use.

10. The receptacle of claim 9, wherein the plurality of securing elements comprise adhesive strips placed near the opening and near a midpoint of the bag.

11. The receptacle of claim 9, wherein the plurality of securing elements are arranged as horizontal bands extending partially around the circumference of the bag.

12. The receptacle of claim 9, wherein at least one securing element comprises a magnetic pad enclosed in a polymer sleeve.

13. The receptacle of claim 9, wherein the bag includes side gussets and the securing elements are positioned on the gusset panels.

14. The receptacle of claim 9, wherein the securing elements include visual markings indicating placement orientation for a user.

15. A method of securing a receptacle inside a container, comprising:
providing a bag having at least one securing element affixed to an exterior surface;
removing a protective cover from the securing element, if present;
pressing the securing element into contact with an interior surface of the container to hold the bag in place; and
disposing items into the bag while the securing element resists dislodgement and the bag remains concealed from exterior view.

16. The method of claim 15, further comprising positioning the bag such that the opening of the bag aligns with a rim of the container.

17. The method of claim 15, wherein the securing element is a hook-and-loop fastener and the method includes engaging it with a matching surface inside the container.

18. The method of claim 15, further comprising discarding the bag and replacing it with a second bag having a similar securing element.

19. The method of claim 15, wherein the bag is compostable and the securing element is biodegradable.

20. The method of claim 15, wherein the bag is packaged in a kit including an installation guide and an applicator for placing matching fastener surfaces in the container.
